(19) United States
(12) Patent Application Publication
(10) Pub. No.: US 2005/0261959 A1
(43) Pub. Date: Nov. 24, 2005

(54) System and method for targeted marketing through intermediate resellers

(76) Inventor: Michael Dirck Moyer, Chicago, IL (US)

Correspondence Address: David G. Rosenbaum;ROSENBAUM & ASSOCIATES, P.C., Suite #380, 650 Dundee Road, Northbrook, IL, 60062, US

(21) Appl. No.: 10/850,553

(22) Filed: May 20, 2004

(51) Int. Cl. G06F 17/60

(52) U.S. Cl. 705/14

(57) ABSTRACT

A targeted marketing system and method for acquiring target specific data useful in marketing goods or services from target groups who have business relationships with goods or services resellers, delivering targeted, vendor-sponsored marketing campaigns directed to the targeted groups and distributing offers or incentives identified with and approved by the resellers, tracking offer response and reporting the data to vendor-sponsors in such a way as to protect the privacy of personally-identifiable consumer data.

### BACKGROUND OF THE INVENTION

The present invention relates generally to methods of targeted marketing of goods or services to identified consumers. More particularly, the present invention is a targeted marketing method in which a mercantile or service vendor, such as a manufacturer, who lacks direct access to ultimate consumers of the goods or services offered by the manufacturer, is able to obtain certain information about the ultimate consumers. Since the ultimate consumer typically has a business relationship with an intermediate reseller of the manufacturer's goods or services, not with the manufacturer, and oftentimes the manufacturer is contractually or otherwise legally prohibited from obtaining certain information directly from the consumer due to privacy issues, it is extraordinarily difficult for manufacturers to obtain sufficient information concerning consumer purchasing habits or purchasing interests in order to selectively market their goods and services on an efficient basis having higher purchasing yields.

Businesses continually seek to maximize their marketing efforts to increase their business without wasting valuable resources. Traditionally, a business markets its product or services to the public regardless of demographics in hopes that casting a wide net will result in reaching interested consumers and, ultimately, reach a potential customer. This approach does not incorporate any consumer research. Therefore, while this saves upfront expenses, the results are unpredictable.

Other businesses try to increase their efficiency in marketing by targeting preferred demographics. One example of this is advertising in select markets based on traditional knowledge, such as males for sports and stay at home mothers for daytime television, or based on viewer data.

One example of legal constraints placed upon manufacturers or service providers in identifying consumer purchasing patterns or interests is the recently enacted Health Insurance Portability and Accountability Act, commonly known as HIPAA. HIPAA was enacted to ensure the privacy of individual patient data in a health care setting and protect patient information from disclosure for marketing purposes. Healthcare patients must be notified of their privacy rights and be given an opportunity to “opt-out” having their information used for marketing purposes. Similar privacy legislation has been enacted with regard to insurance and financial information, among other things. Thus, there are considerable legal obstacles preventing manufacturers or service providers from obtaining and using consumer information for marketing purposes.

It is-recognized in the art, that it is desirable for manufacturers or service providers to be able to selectively market only to prospective consumers who will have a higher likelihood of purchasing the goods or services offered. However, without the ability to obtain consumer information, manufacturers and service providers are left without viable avenues to target their marketing efforts to those consumers. Thus, there are many manufacturers or service providers who are unable to effectively or efficiently obtain consumer information or be in direct contact with the ultimate consumer due to the existence of the legal and contractual “black box” which protects prospective consumer identity from use in marketing efforts.

Efforts have been made to overcome this “black box” and permit manufacturers or service providers to obtain consumer information. For example, Mize (U.S. Patent Publication 2003/0204417) discloses is a membership-based program where the consumer selects and signs up for specific programs. The program enables the consumer to obtain savings on products and services that fall under the program. Upon the purchase of such products and services, there is a tracking mechanism for recording the purchase and assigning this record to the profile of the consumer. For example, a vendor, through an identification card, can track a pet owner's spending habits. Pet owners essentially sign up for programs, which are facilitated through an identification card that incorporates incentives for its use. Upon its use, the activities are recorded for ultimate use by the vendor. While this methodology includes a feedback mechanism for determining the success of a vendor's marketing effort, this method is based on the active participation and subscription of a consumer, e.g., a pet owner, to a desired marketing campaign.

Saxe (U.S. Pat. No. 5,636,346) discloses a system for targeted advertising and programming to television subscribers by matching a database of programming subscribers, e.g., cable providers, to that of a company's targeted marketing group to select specific subscribers without identifying them. The system maintains privacy by converting the television subscribers to codes that are secured and can be matched with a company's desired targeted marketing group. Specifically, a cable subscriber's records can be altered and encoded, thus allowing demographic, lifestyle, and viewing habits to be associated to the subscriber without identifying the name and address. This allows for more targeted advertising and programming to each subscriber without violating the subscribers privacy of their information. However, this targeted methodology lacks any discussion of receiving a direct response from the consumer/customer in response to a marketing effort and relaying this information back to the vendor to determine the success of their marketing effort.

Still others, such as Long et al. (U.S. Patent Publication No. 2002/0026359), have disclosed a method of targeted advertising by tracking the response of a consumer, preferably through the use of a coupon. The “targeted” aspect of this method is the modification of the advertising based on tracking the response by accumulating data resulting from the use of the coupon by the consumer. While this reference discloses a method that includes targeted advertising or promotion and response tracking for purposes of modifying advertising or promotion in efforts to improve the effect, the reference fails to disclose a consumer database search to match select advertising/promotion campaigns with consumer profiles.

Although there have been a variety of attempts at enhancing the business of a company by providing a more successful method of advertising, there still remains a need for an effective targeted advertising system which proactively involves the manufacturer or service provider and the reseller in data acquisition, processing, offer selection, offer dissemination and offer redemption. In particular, there is a need for an effective targeted advertising system directed towards consumers that form an intimate consumer database of the intermediate reseller in such a manner that protects the privacy of the consumer, while allowing for the flow of target-specific information to the manufacturer or service provider and the selection of offers and promotional materials by the reseller targeted to the resellers consumers.

### SUMMARY OF THE INVENTION

The present invention generally addresses the remaining needs in the field of targeted advertising, as discussed above. In general, the present invention is directed towards a system and a method of using the system to selectively market products or services of a vendor to a consumer.

An aspect of the present invention comprises a system and method of using the system to selectively market products or services of a vendor to a consumer whose identity and information is present in an intimate database belonging to an intermediate reseller. The method generally comprises the steps of: compiling a database of consumer profiles by the reseller that provides detailed information about a consumer; matching the specifications of a marketing program sponsored by a vendor to the consumer profiles in the database; identifying eligible marketing programs for the consumer; providing an incentive offer to the consumer to respond to the marketing program; collecting a response from the consumer and determining the response rate of the marketing program. A further step of analyzing the response rate from consumers and adjusting the parameters of the marketing program may be executed by the vendor.

In another aspect of the present invention, the compiling step comprises a step of the reseller obtaining consumer answers to survey questionnaires and entering the survey answers into a reseller maintained consumer database resident on a reseller computer, preferably operating under MICROSOFT WINDOWS or compatible operating software. Alternatively, the data acquired from survey answers can be entered or updated by the consumer online or by a data entry service.

In yet another aspect of the present invention, the matching step comprises inputting specific parameters of the vendor marketing program into a computer, preferably operating under the MICROSOFT WINDOWS or compatible operating system. Among the specific parameters for the vendor marketing program, the vendor specifies the budget for the marketing program, the offer and the target information for consumers. The matching step may also include an optional determination step, determining available funds in the marketing program to determine whether the marketing program is available for presenting to the consumer. Moreover, the matching step may also include an additional response analysis to determine the members of the target audience most likely to respond, such as customer scoring.

In accordance with another aspect of the invention, an administrator management computer is provided which acts as a blind between the vendor and the reseller and manages funded marketing campaigns for the vendor, manages reseller subscriptions to the funded campaigns and permits any intermediate distributors to oversee the vendor marketing campaigns for both the vendor and the reseller. In one particular aspect of the invention, the consumer is able to view and edit their survey data online, at an in-store kiosk or by a paper questionnaire.

A further aspect of the present invention includes the step comprising selecting the matched marketing program, which additionally may include an analysis of consumer survey responses, for the consumer and conveying the discount offer or another incentive for the consumer to participate in the survey. Preferably, the discount offer is a coupon for a product or service of the vendor. In an alternative aspect, the present invention further includes a step of reviewing the survey data to select the matched marketing program with the greatest potential for success.

In another aspect, the present invention comprises the collecting step comprising redeeming the discount offer by the consumer with the reseller. Preferably, the collecting step comprises recording the redeemed discount offer by the reseller on a computing device through a graphic user interface. The coupon has a tracking method incorporated into the coupon, preferably a tracking barcode.

Another aspect of the present invention further comprises an optional step of rewarding a user who inputs data associated with one of the compiling or collecting steps by giving the user credit for each data recorded. Preferably, the rewarding step includes tracking the credit earned by the user for each input of data.

Another aspect of the present invention is a system for allowing a vendor to selectively market products or services to a consumer belonging to an intimate consumer database of a reseller, comprising: a computing device; a graphic user interface for inputting data into the computing device; a database for storing data and organizing the data; and a software application for processing the data in the database and returning datasets based upon input parameters pertaining to a sponsor's marketing campaign.

In all aspects of the invention, the present invention provides for communication between a plurality of remote computers at the vendor, distributor, reseller and management sides of the system. Such communication is preferably over secured internet access employing the world wide web (“WWW”), employing at least 128-bit RSA public key encryption (RSA Security, Inc., Bedford, Mass.) using an appropriate WWW browser such as MICROSOFT INTERNET EXPLORER or NETSCAPE NAVIGATOR. Appropriate login security is provided at each of the remote computer sites for the vendor, distributor, reseller, end-consumer and management sides of the system.

### BRIEF DESCRIPTION OF THE DRAWINGS

FIG. 1 is a flowchart illustrating a high level overview of the inventive system and method.

FIG. 2 is a flowchart illustrating operational functions and data relationships with the system and method of the present invention.

FIG. 3 is a hierarchical diagram illustrating the system of the present invention.

FIG. 4 is a flow diagram illustrating operation of the reseller campaign subscription process in accordance with the present invention.

FIG. 5 is an operational flow diagram illustrating customer data standardization and validation and synchronization of customer data in accordance with the present invention.

FIG. 6 is a flow diagram illustrating vendor marketing campaign reporting in accordance with the present invention.

FIG. 7 is an operational flow diagram illustrating vendor marketing campaign analysis and reporting in accordance with the present invention.

FIG. 8a is a print-out of an Add Patient screen for entering new consumer information according to a preferred embodiment of the present invention.

FIG. 8b is a print-out of an Add Pet screen for entering new pet information according to a preferred embodiment of the present invention.

FIG. 8c is a print-out of a Client (Consumer) Response screen for entering answers to survey questions by the consumer according to a preferred embodiment of the present invention.

FIG. 8d is a print-out of an Opt-In screen for declaring agreement and entering contact information.

FIG. 9 is a print-out of a Coupon Screen for entering new coupon information according to a preferred embodiment of the present invention.

FIG. 10 is a print-out of a reseller menu hierarchy screen in accordance with the present invention.

FIG. 11 is a print-out of an Office Details screen for entering reseller identifying information and is selected from the menu hierarch screen of FIG. 10.

FIG. 12 is a print-out of a confirmation screen displaying reseller identifying information for confirmation.

FIG. 13 is a print-out of a consumer survey modification screen selected from the menu hierarchy of FIG. 10.

FIG. 14 is a print-out of a User Set-Up screen for entering and editing user reseller-side user access information in accordance with the present invention.

FIG. 15 is a print-out of an optional Progress and Points Balance screen for displaying status of marketing campaign progress and points earned in accordance with the present invention.

FIG. 16 is a print out of a Customer Referral screen for entering contact information for a customer referral at the reseller-side of the inventive system.

FIG. 17 is the table structure of a Patient File.

FIG. 18 is a table structure of a User File.

FIG. 19 is a table structure of a Points File.

FIG. 20 is a table structure of an Office Detail File.

FIG. 21 is a table structure of a Referral Contact File, in accordance with the present invention.

FIG. 22 is a print out of a Campaign Launcher screen illustrating office detail information in accordance with the present invention.

FIG. 23 is a print out of an Active Campaigns screen showing reseller status of subscribed marketing campaigns in accordance with the present invention.

FIG. 24 is a print-out of an optional Warning Screen conveying that a reseller subscribed vendor marketing campaign is becoming inactive.

FIG. 25 is a print-out of an optional Sponsor Detail screen containing identifying information of a vendor having a marketing campaign and a summary of the marketing campaign.

FIG. 26 is a print-out of a View Campaign screen displaying specific information concerning the parameters and status of a vendor marketing campaign.

FIG. 27 is a print-out of a View Creative screen accessed from the View Campaign screen of FIG. 26 which permits the reseller to view a facsimile of a vendor marketing campaign offer personalized with reseller information.

FIG. 28 is a print-out of an optional National Response Rate screen conveying information to a reseller concerning national response-rate for a given vendor marketing campaign.

FIG. 29 is a print-out of an optional Availability screen conveying information to a reseller concerning the availability and relative funding status of a vendor marketing campaign.

FIG. 30 is a print-out of a Campaign Recipients screen displaying status information on offers sent to individual reseller consumers in accordance with the present invention.

FIG. 31 is a print-out of an optional Pending Recipients screen displaying information on prospective consumers for a reseller subscribed vendor marketing campaign.

FIG. 32 is a print-out of a Respondents screen displaying information identifying reseller consumers who have responded to an offer from a reseller subscribed vendor marketing campaign and is a subset of data displayed in FIG. 30.

FIG. 33 is a print-out of an Unsubscribe screen which permits a reseller to deactivate or unsubscribe from a vendor sponsored marketing campaign.

FIG. 34 is a print-out of a Campaign Subscription screen accessed by the reseller to view available vendor-sponsored marketing campaigns, obtain information about the same and subscribe to desired campaigns.

FIG. 35 is a print-out of an optional Activate Campaign screen which is used by the reseller to activate or subscribe to a vendor-sponsored marketing campaign.

FIG. 36 is a print-out of an Activate Campaign Warning Screen which displays that the reseller is unauthorized to activate the selected vendor-sponsored marketing campaign.

FIG. 37 is a print-out of a first screen of an Activate Campaign Confirmation screen which requires the user to confirm campaign activation.

FIG. 37B is a print out of a second screen of an Activate Campaign Confirmation screen which displays a confirmation that the reseller has successfully subscribed to the selected vendor-sponsored marketing campaign.

FIG. 38 is a print-out of an optional Subscribed Campaign Warning screen for assigning non-conflicting priorities to reseller subscribed vendor-sponsored marketing campaigns.

FIG. 39 is a print-out of an Inactive Campaigns screen displaying information about previously subscribed, but inactive vendor-sponsored marketing campaigns.

FIG. 40 is a print-out of an optional Mail Settings screen which permits the reseller to specify parameters for offer mailings to reseller consumers.

FIG. 41 is a print-out of a Campaign Manager screen that is displayed on the vendor-sponsor side of the system and permits the vendor-sponsor to manage the vendor-sponsored marketing campaigns in accordance with the present invention.

FIG. 42 is a print-out of an optional Vendor Campaign Deactivate screen which permits a vendor to deactivate a vendor marketing campaign.

FIG. 43 is a print out of an optional Vendor Campaign Activate screen which permits a vendor to activate a vendor marketing campaign.

FIG. 44 is a print-out of an optional Vendor Campaign Reactivate screen which permits a vendor to reactive a previously active, but deactivated vendor marketing campaign.

FIG. 45 is a print-out of an optional Edit Budget screen which permits a vendor to edit an assigned budget for a vendor marketing campaign in accordance with the present invention.

FIG. 46A&B are a print-out of a Campaign Detail Report screens generated on the vendor side of the inventive system which details demographically the status and results of vendor marketing campaigns for an individual vendor-sponsor.

FIG. 47 is a print-out of a Set E-mail screen which permits the vendor-sponsor to communicate by email with subscribed resellers concerning vendor marketing campaigns.

### DETAILED DESCRIPTION OF PREFERRED EMBODIMENTS

In addition to the drawings, the following description of embodiments of the present invention are illustrative of preferred embodiments and are not intended to limit the scope of the present invention.

A health care provider is a perfect example of an ongoing business relationship between a reseller and a consumer. The health care provider is successful in his or her business by developing a large consumer clientele, who are typically tracked by recording each consumer's information in a file or as part of a consumer database. There is further success by keeping each consumer long term and, thereby, receiving ongoing business from each and every consumer. Obviously, in such a relationship, there is a level of trust and comfort required to maintain the relationship. Therefore, the health care provider's database of consumers is fertile ground for soliciting further business, but the consumer has to be handled carefully because of the sensitivity of the relationship. And, while there is evidence that health care providers would like to engage in marketing to their clientele, they typically lack the resources or expertise to do so. Additionally, because of the sensitive nature of the consumer relationship, the health care provider does not (and often legally can not) share data with third parties to who wish to market to their clientele directly (i.e. sell or rent their database). Additional examples of service providers who would benefit from the present invention are beauty salons, spas, repair shops, or the like.

“Targeted Marketing System” refers to the inventive system, which is used to practice the methods described herein. The Targeted Marketing System allows a Vendor to solicit business from a screened consumer, or targeted consumer, wherein the consumer is a client/patient of a Reseller, e.g., a patient of a dental practice. The Targeted Marketing System includes Reseller-end software, including a Data Collection Tool and a Web-based Campaign Launcher, Vendor-end software, including a Web-based Campaign Manager, and Administrator-end software, including Web-based Administration Tool. This software allows the Vendor and Reseller work together and with the Administrator to benefit the business of both Vendor and Reseller, while keeping all sensitive information of the patient/client of the Reseller confidential. Optionally, a consumer interface may be provided that permits the consumer to view and edit on line their personal information, survey detail or offers that is stored in the Targeted Marketing System.

“Administrator” is used to describe a company that manages or a manager of the Targeted Marketing System that utilizes the Web-based Administration Tool to coordinate and process data received from both the Vendor and the Reseller.

“Reseller(s)” is used to describe a business, and those that act for the business, that provides a-product or service, e.g., veterinarian, dentist, physician, law firm, consulting firm, retailer, optometrist, physical therapist, personal trainer, accountant, hair stylist, massage therapist, auto mechanic, and etc., to its consumer customers.

“User” is used to describe an employee of a Reseller that is authorized to access the Reseller-end software that is a part of the present invention, including the DCT and WCL software. The User is typically assigned the responsibility of entering and updating data via the Reseller-end software and, sometimes, affecting the transmission of information between the Reseller and the Administrator through Web-based communication. In an alternate embodiment, the User can be allocated reward points for each act of data entry and/or update, including the addition or update of patient profiles, patient survey responses, marketing feedback (e.g., coupon redemption), Reseller office information, and office referral information.

“Vendor” or “Sponsor” is used to describe a business that seeks to market a product or service through a reseller to a reseller's customer consumer. In some instances the term “Manufacturer” is used to represent a Vendor or Sponsor as understood to be an element of the targeted marketing system. The vendor funds a marketing program that is created to provide marketing materials to the consumer through the reseller.

A “Campaign” or “Marketing Campaign” is used to describe a marketing program put together and funded by the vendor that utilizes the Targeted Marketing System.

In accordance with one embodiment of the present invention, the Reseller receives a copy of the Data Collection Tool (“DCT”) and installs it onto the Reseller's computer. The Reseller then registers via the internet at a web-site provided by the Administrator. While registering for the Targeted Marketing System, the Reseller is provided with a unique identifier that distinguishes the Reseller from other resellers. Registration includes the Reseller providing its office name, office contact information and a chosen password. After the DCT program is initiated, a Reseller accesses a Register window through a Help/Register menu and the Reseller logs on by entering the unique identifier assigned to the Reseller and along with the Reseller's chosen password.

Data is transferred from the Reseller to the Administrator by accessing the Data Transfer Setup window available from the Settings/Data Transfer Setup menu using the DCT program. Typically, data transfer is facilitated by either a) secure internet connection, or b) a dial-up internet connection. For instances when a regular data transfer is required on a periodic basis, e.g., on a weekly or daily basis, automatic data transfers are established by providing the proper settings using the Schedule tab found in the Data Transfer window.

The Reseller enters information about the Users that have access to the Reseller-side software including the DCT. This is done in the User Setup window accessed through the Settings/User Setup menu.

Outside of the automatic data transfers, a User can transfer data manually by accessing the File/Transfer Data to Administrator menu. As data is collected by the Administrator using the Web-based Administration Tool (“WAT”), the User can visit the Administrator's website and check the data that they entered using the DCT. Where the optional points and reward system is implemented, the User is awarded reward points for every time the User enters and/or modifies data. The accumulated reward points for each User can be checked on the Administrator's website, also. To access all this information, the User logs into the Administrator's server using the same unique identification and password as used to log into the DCT. Any changes made to the unique identification or password is update on the Administrator's server upon the next data transfer.

The website of the Administrator (“Central Website”) is intended to serve as central location where information collected by DCT is stored, collected and retrieved by a Reseller for viewing. The Central Website, as well as the DCT, is an integral part of the Targeted Marketing System. The Central Website works in conjunction with the DCT and provides the following functions:
receiving data collected by the DCT program;
storage of information received from Resellers;
information service provided to a DCT User that allows viewing of information entered by that User and, optionally, their reward points; and
an Administrator interface allowing to the Administrator to view registered Users and Resellers and view the information seen by the Users.

Users of the DCT may use the Central Website for all but that which is accessible by administrator level employees of the Reseller. To access the Central Website, Users should use their unique identification, or user name, and password they use to login to the DCT and the name or unique identification of the Reseller. Once a User is within the login page of the Central Website, the User selects the Reseller from a Reseller Name list and the appropriate unique identification and password are entered in appropriate boxes. Upon clicking a Login button, the Administrator's server verifies the provided credentials and logs the user in if they are valid. If unique identification or password is not valid, the Administrator's server returns the User to the login page with a “Login failed” message. If a unique identification or password is changed by a User or a local administrator in the DCT, they are changed and used to login DCT immediately. However, the changed credentials are not updated on the site until the next data transfer from the DCT to the Administrator's server. Therefore, between this change and data transfer, different pairs of these values are used to login to the DCT and the Administrator's Server. Alternatively, the set of unique identification and password for logging into the Administrator's Server is independent from that of the DCT software.

Upon successful login, a user panel opens containing links to the following site areas:
Patient list;
Coupon list;
Referral list;
Progress and points page, where implemented;
Logout.
   The Patient list page displays the list of patients that the User entered in the DCT and that have been transferred to the Administrator's Server. Patients that were entered by users of other Resellers are not seen. For every entered patient the User is awarded with 1 reward point where the optional points and reward functionality is implemented.

The Coupon list page displays the list of coupons that the User entered in the DCT and that have been transferred to the Administrator's Server. Coupons that were entered by other users are not seen. Optionally, for every entered coupon, the User is awarded with 1 reward point. The Administrator's server will issue coupons and validate coupons transferred from the Reseller's DCT against the Administrator's Server database.

A Referral list page displays the list of referrals that the User has entered into the DCT and that have been transferred to the Administrator's Server. Referrals that were entered by users of other Resellers are not seen. Optionally, the User is awarded points for entry of referrals on a monthly basis based on every valid referral.

In accordance with one embodiment, a Progress and Points page provides the User an interface that allows the User to track reward points that were awarded to the User during various periods of time. There is an ability to view the most important parameters such as number of reward points for the last week or for the current month, and to view graphic charts that display trends across days of any month and months of nay year. Reward points are awarded during data transfer process, so a User will not see new points that should be awarded until after the next data transfer. The following parameters are calculated and displayed at the top of the page:
Points Today—number of points awarded today so far;
Points This Week—number of points awarded for the period form the start of current week to present moment;
Points Last Week—number of points awarded last week;
Points Current Month—number of points awarded for the period form the start of current month to present moment;
Points Last Month—number of points awarded last month.
   The following charts are displayed:
Daily Progress—chart detailing the number of points awarded for each day during specified month (by default, current month);
Monthly Progress—chart detailing the number of points awarded for each month during specified year (by default, current year).
   Each chart has a list located beneath it allowing selection of another month or year. This makes it possible to view another month and year besides current ones. Upon selection, a Refresh Button should be pressed to update the page. This page may be printed using the Print command of the browser, e.g., using the pull down selection from the File/Print menu in Microsoft's Internet Explorer.

When a User is through viewing information in the user panel, the User may log out from the site to ensure that the current session is closed and that no one can view the user panel without valid credentials, or to allow another User to log in from the same browser window.

The use of the Central Website by the Administrator is restricted so that the Administrator can view lists of registered Resellers and Users and any information that any User may see. The Administrator may login to the Central Website using a predetermined access password. If the password is not valid, the site returns to the login page with “Login failed” message.

When the Administrator is through with viewing information in the Administrator panel, the Administrator may log out from the Central Website to ensure that the session is closed and that no one can view the Administrator panel without valid credentials.

The Reseller that has installed the DCT needs to register onto the Central Website to become qualified for transfer of data entered into the DCT to the Administrator's Server. Or, preferably, the DCT software will automatically register onto the Central Website when communicating with the Central Website. This registration process collects information about Resellers, issues them a unique identification number and allows them to choose an access password. A Reseller Registration page opens a form where information on the Reseller and access password should be entered. When all required information is entered, a Register button should be clicked. Upon successful registration, a page opens with issued Reseller unique identifier (number) that should be memorized or written down along with the entered password. To enable the DCT to transfer data, the Reseller should enter the issued unique identification number and password in the Help/Register window of the DCT. If this information is not entered, the data will not be transferred.

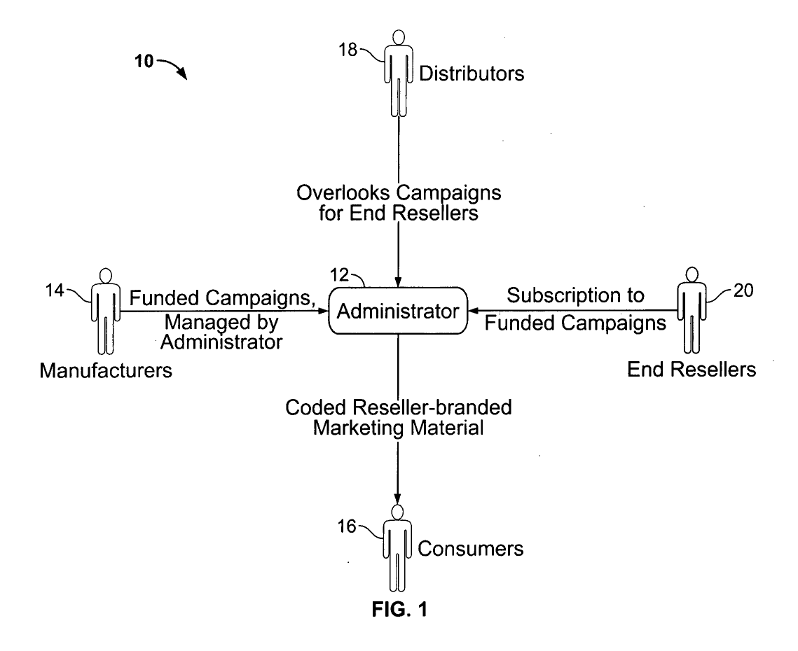

As illustrated in FIG. 1, the Targeted Marketing Network 10 consists generally of a central Administrator 12 that operates, maintains and oversees the computer systems, servers and databases of the Targeted Marketing System, offers and subscribed resellers. The Administrator 12 interacts to receive information from Vendor/Manufacturers 14 concerning funded marketing campaigns and manage the marketing campaigns based upon subscriptions received from Resellers 20, to convey coded reseller-branded marketing materials to Reseller's consumers 16. Alternatively, the consumer 16 has the ability to view their profile and enter updates and modifications as necessary. Distributors 18 may be involved in the marketing distribution chain and act on behalf of the Vendor 14 to oversee marketing campaigns

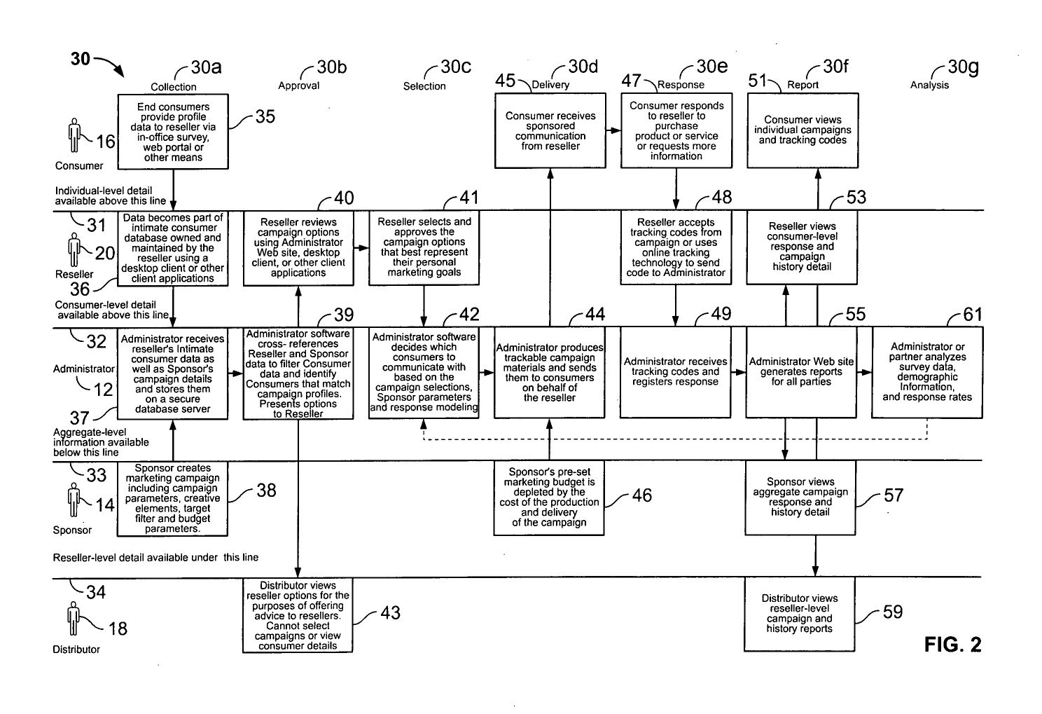

FIG. 2 is an enterprise-level flow diagram illustrating the system and method of the present invention 30. The system is divided into consumer 16 side functionality, reseller 20 side functionality, administrator 12 side functionality, sponsor 14 side functionality and distributor 18 side functionality. Data is filtered and screened between the consumer 16 and the reseller 20 at a first level 31 in which only individual level information detail is available to the consumer, and is filtered and screened between the reseller 20 and the administrator 12 at a second level 32 in which only consumer-level information detail is available to the reseller 20. Data is also filtered and screened between the distributor 18 and the sponsor 14 at a third level 34 such that only reseller-level detail information is available to the distributor 18. Finally, data is filtered and screened at a fourth level 33 between the administrator 12 and the sponsor 14 such that only aggregate-level information is available to the sponsor 14. In this manner, the individual-level consumer information available at the first level filter 31 is secure against disclosure at any other level in the system 30.

The system 30 functionality is generally categorized into several discrete, but interacting general functions: collection 30a, approval 30b, selection 30c, delivery 30d, response 30e, reporting 30f and analysis 30g. Data collection begins with the consumer 16 who provides profile data to the reseller via an in-office survey, web portal or other means at step 35. The consumer data is input into and becomes part of an intimate consumer database owned and maintained by the reseller at step 36. At step 37, the administrator receives the reseller's intimate consumer database and stores only consumer-level detail data, not individual level consumer data, on a secure database server. At step 38, the sponsor 14 creates a marketing campaign, including direct mail, e-mail, telemarketing, web-links or banners, or the like, and designs any creative elements, target filters and budget parameters for the marketing campaign. Step 37 further includes the administrator 12 receiving campaign details and storing them on a secure database server. Both the consumer data from 35 and the campaign data from step 38 may be stored on the same server or on different servers which may be either local or remote to one another. In this manner collection function 30a is accomplished.

The approval function 30b begins with step 39 in which the processing software resident at the administrator 12, cross-references reseller and sponsor data to filter consumer data and identify consumers that match campaign profiles. Matched campaign profile data and options are presented to the reseller at step 40. In step 40, the reseller reviews the campaign options using an administrator 12 web site. In step 43, the distributor may view reseller options for the purpose of offering advice to the resellers 20. The distributor 18, however, cannot select campaigns or view consumer details. In this manner the approval function 30b is accomplished.

The selection function 30c is accomplished by the reseller 20 selecting and approving at step 41 the campaign options best representing their marketing goals. Then, at step 42, the administrator 12 processing software determines which consumers to communicate with based upon the campaign selections, sponsor parameters and statistical modeling at step 42.

The delivery function 30d is initiated by the administrator producing campaign materials which are then sent at step 44 to the consumers on behalf of the reseller on the basis of the resellers selected and approved campaign options. In step 46, as the campaign materials are produced, the sponsor's pre-set marketing budget is decremented by the cost of production and delivery of the campaign materials in step 44. The consumers receive the sponsored communication from the resellers as sent by the administrator in step 44.

Response function 30e occurs when a consumer responds to a reseller's campaign materials in step 47 by purchasing a product or service or by requesting further information. In step 48, the reseller accepts the consumer response by receiving the campaign materials from the consumer and accepting tracking codes in the campaign materials, or by using online tracking to forward the tracking code to the administrator 12. The administrator 12 then receives the tracking codes and registers the consumer response to the campaign material at step 49.

The reporting function 30f is initiated by the administrator 12 generating reports for all parties, which are preferably generated or posted on the administrator web site in step 55. The reseller is able to review consumer-level response and campaign history detail in step 53, the consumer is able to view individual campaigns and tracing codes as step 51, the sponsor is able to view aggregate campaign response and history detail at step 57, and, finally, the distributor is able to view reseller-level campaign and history reports at step 59.

Finally, an analysis function 30g whereby either the administrator 12 or a partner, analyzes the survey data, demographic information and response rates at step 61, with the results of the analysis being compiled in scoring or rating values for the consumers, which is then feedback to step 42 in the selection function 30c, to facilitate executing step 42 in which the administrator software determines which consumers to communicate with based upon the campaign selections, sponsor parameters and response modeling carried out in step 61. As the system operates over time, the rating or scoring values produced by the analysis function 30g, are constantly revised and fed back into the selection function 30c at step 42 to refine and improve the response modeling. Thus, in a manner like artificial intelligence, the system operates to improve its selection function 30c on the basis of the rating or scoring values from the analysis function 30g.

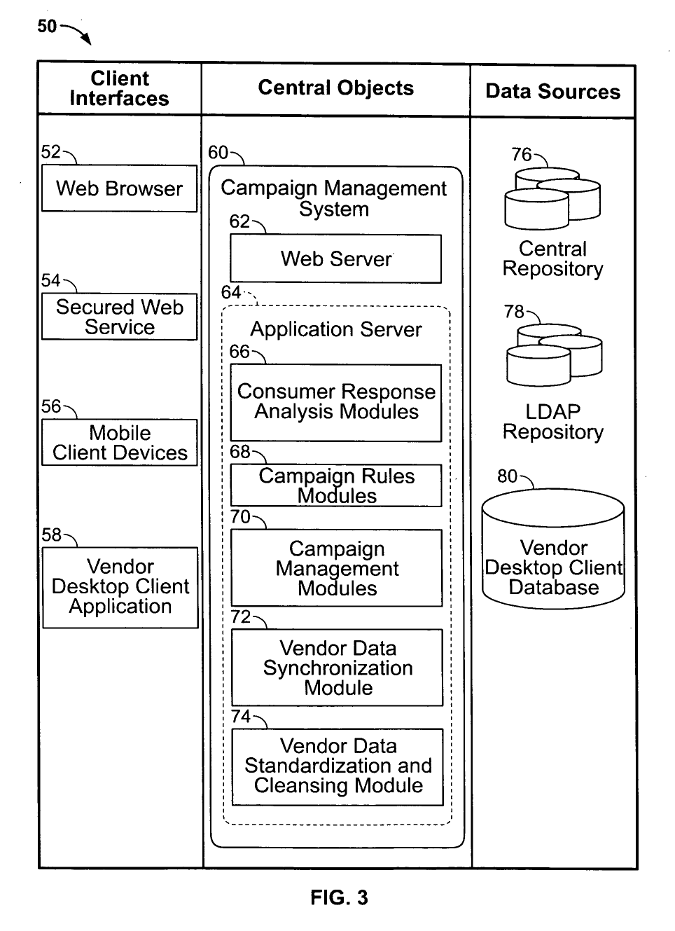

In FIG. 3, the various elements of the Targeted Marketing System and elements that interact therewith are shown in a table 50 under the listings: consumer interfaces, central objects, and data sources. The consumer interfaces include a Web Browser 52, a Secured Web Service 54, a Mobile Consumer Device 56 and a Vendor Desktop Consumer Application 58. The central objects of the Targeted Marketing System include a Campaign Management System 60, which is comprised of a Web Server 62 and an Application Server 64. The Application Server 64 is comprised of a Consumer Response Analysis Module 66, a Campaign Rules Module 68, a Campaign Management Module 70, a Vendor Data Synchronization Module 72, and a Vendor Data Standardization and Cleansing Module 74. All the central objects work with data provided by the various data sources, including: a central repository 76, a Lightweight Directory Access Protocol (“LDAP”) repository 78 and a Vendor Desktop Consumer Database 80.

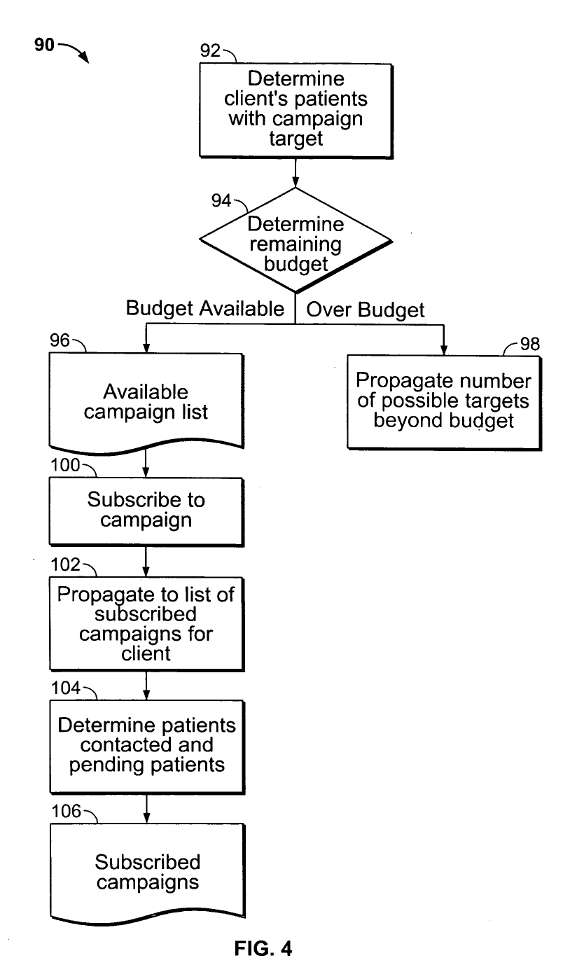

Referring to FIG. 4, there is illustrated a flow diagram of the subscribing of specific marketing campaigns by a reseller 90. A match determining step 92 is made to match a marketing campaign with consumers that form a reseller's intimate consumer database. From this match determining step 92, a budget determination is made, as represented by the budget determining step 94, to confirm the availability of any selected marketing campaigns. If over budget, there is an over budget analysis 98 made to determine the number of targets, or resellers, that are above the allotted budget for the marketing campaign of interest. If within budget, an available campaign list 96 is created, which provides all potential marketing campaigns available for a reseller. From there, the reseller undergoes a campaign subscribing step 100, which consists of the reseller subscribing to a particular marketing campaign. Upon subscribing to a particular marketing campaign, a further step of listing subscribed campaigns for reseller 102 is processed to supply information on all marketing campaigns enlisted by each reseller. Next, the reseller undergoes a patient contact step 104 to track all contacted and pending contacts. A campaign subscribing step 106 is processed to subscribe consumers or patients of a reseller to subscribed marketing campaigns. Preferably, this step includes communicating with the Administrator through the Web-based Administration Tool, who then processes and updates the subscription by the reseller.

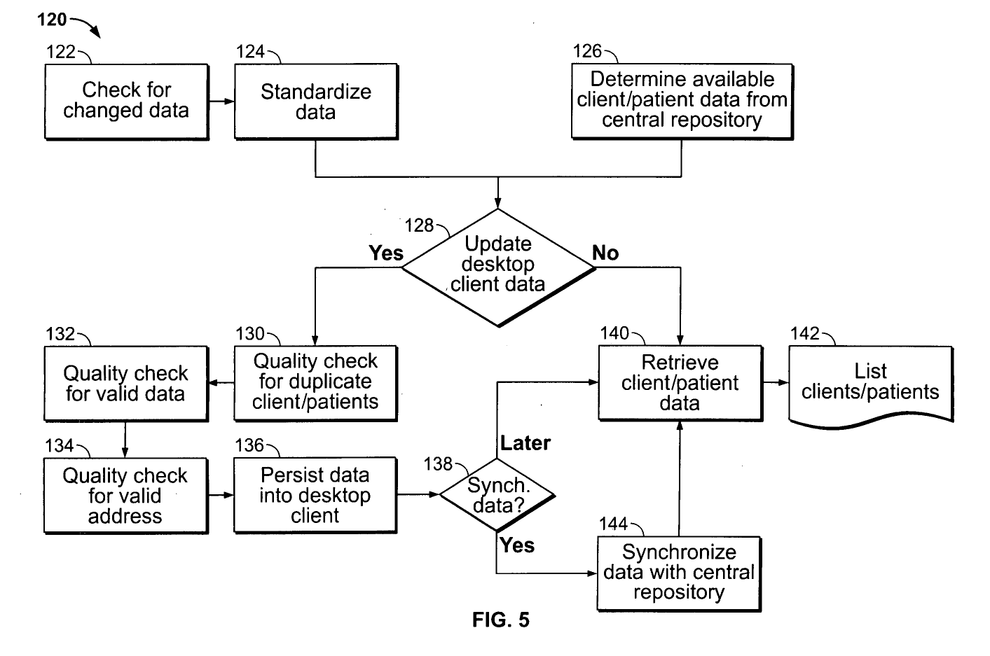

Referring to FIG. 5, there is a flow diagram illustrating the process for retrieving and updating consumer or patient databases through the Targeted Marketing System 120. An initial database is checked 122 and then data is standardized in a data standardization step 124. Also, a determination of available consumer/patient from the central repository 126 is made. From there, the consumer/patient data update decision on the desktop level is made 128. If no to an update, the consumer/patient data is retrieved by the reseller in a patient date retrieval step 140. A consumer/patient list 142 can then be made available to the reseller. If yes to an update, a quality check for redundancy 130 is made, which eliminates the existence of any duplicate entries. Next, a quality check for valid data 132 is made to remove any aberrant entries. After the quality check for valid data 132, a quality check for valid addresses 134 is made, which will eliminate any wasteful contact with a defunct address, e.g., mailing marketing material to a nonexistent or an old address. Once the checks are made, the data is confirmed into the reseller's database in the reseller's desktop through a reseller persist data step 136. This desktop data can then go to the synchronize data decision 138. If later is decided, then the data is retrieved in the patient date retrieval step 140. If yes, the data is synchronized'with the central repository 144. Thereafter, the synchronized data can then be retrieved in the patient date retrieval step 140. From the patient date retrieval step 140, a reseller can get a list of consumers/patients 142 that make up the pool of consumers available for matching with eventual subscribed marketing programs by the reseller.

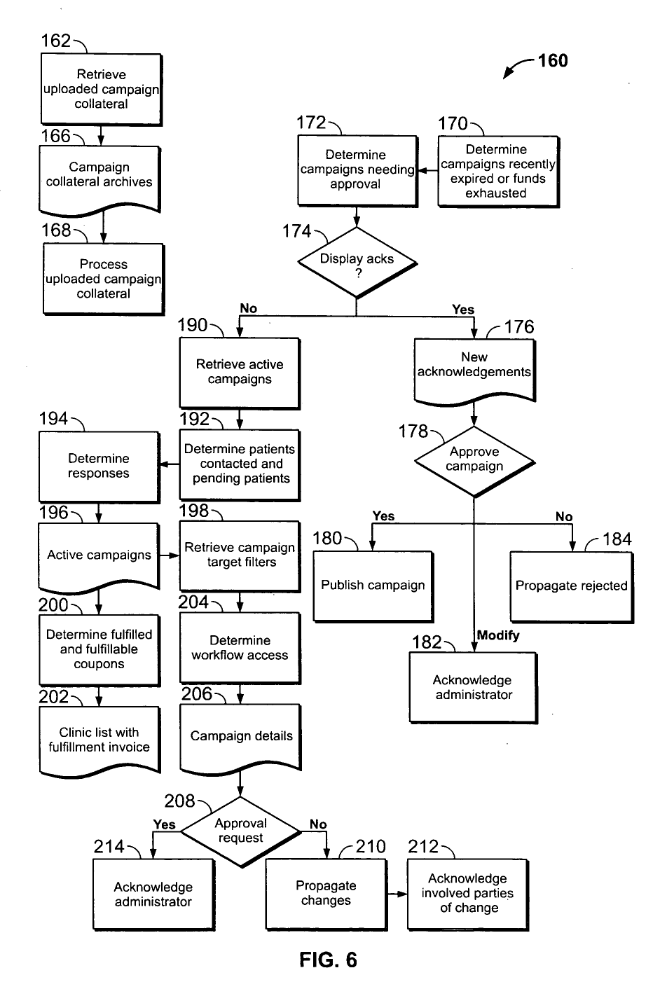

Referring to FIG. 6, there is illustrated a flow diagram for the monitoring and updating of marketing campaigns by a vendor or manufacturer 160. A vendor can retrieve uploaded collateral 162 and then archive the campaign collateral 166. After archiving the campaign collateral 166, the vendor can process uploaded campaign collateral 168. Additionally, a vendor performs a campaign determination step 170 of determining campaigns recently expired or funds exhausted. This campaign determination step 170 will eliminate the processing of any defunct marketing campaigns. After the campaigns are determined to be available and funded, approval step 172 is undertaken to determine if any approval is required for a particular campaign. From there, a decision for determining whether to display acknowledgements 174 is made. If the decisional response is affirmative, then new acknowledgements 176 are determined. Once the new acknowledgements 176 are determined, an approve campaign decision step 178, for approving a campaign, is made and the campaign is published at step 180. If the decisional response is negative, then the campaign propagation is rejected 184. If the decisional response is “modify”, then the administrator is acknowledged 182. If no to the display acknowledgments 174, then the vendor shifts towards retrieving active campaigns 190. Once retrieved, a step of determining patients contacted and pending patients 192 is undertaken. From this determining step 192, responses from patients are determined 194. Then active campaigns 196 are determined and accessed. Once the active campaigns 196 are determined, the vendor can determine fulfilled and fulfillable coupons 200, and thereafter provide reseller with a fulfillment invoice 202. On the other hand, once the active campaigns 196 are retrieved, the vendor can retrieve campaign target filters 198, thereby leading to a determination of workflow access 204. Afterwards, campaign details 206 are accessed and then an approval request decision 208 is undertaken. If the decision is yes, then an administrator is acknowledged 214. If the decision is no, then changes are propagated 210. Once propagated 210, acknowledge involved parties of change 212

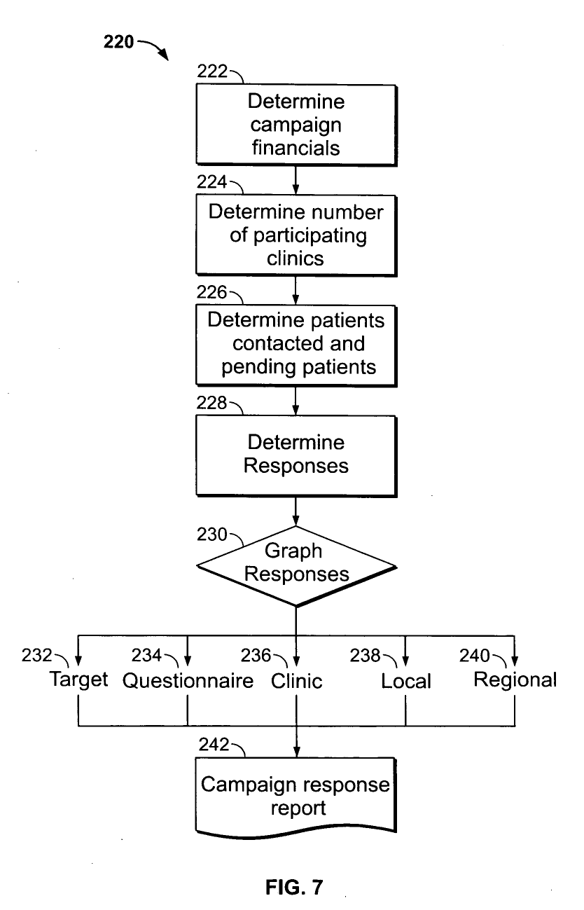

Referring to FIG. 7, there is illustrated a flow diagram of a vendor regarding producing a campaign response report 220. Initially, campaign financials are determined 222. Once the financials are determined, the number of resellers is determined 224. These represent the various resellers, or typically service providers, that have subscribed to the vendors marketing campaign. From there, the patients contacted and pending patients are determined 226. These patients represent the consumers that have been identified from the participating or subscribed reseller's client/patient database. From these patients/clients, responses are determined 228. The responses are solicited for determining a measure of effectiveness of a particular marketing campaign. The graphed responses 231 are provided in a graph response step 230 and are broken down into various parts including target 232, questionnaire 234, clinic 236, local 238 and regional 240. This provides a list of information to chart and analyze to determine the effectiveness of a marketing campaign in a particular area or to a particular group of consumers or to a particular type of reseller. From the graphed responses 231, a campaign response report 242 is formulated to convert the raw information into a presentable result. The campaign response report 242 can be utilized by the vendor to help determine the aspects of the marketing campaign that was effective and should be continued, and the aspects that were ineffective and should be eliminated.

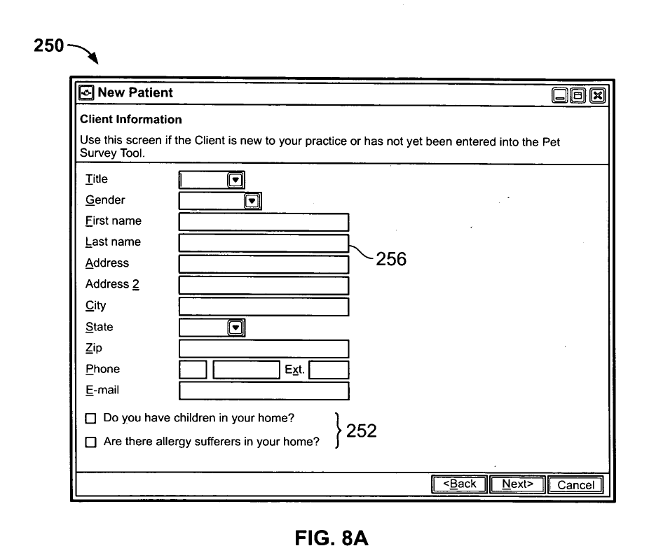

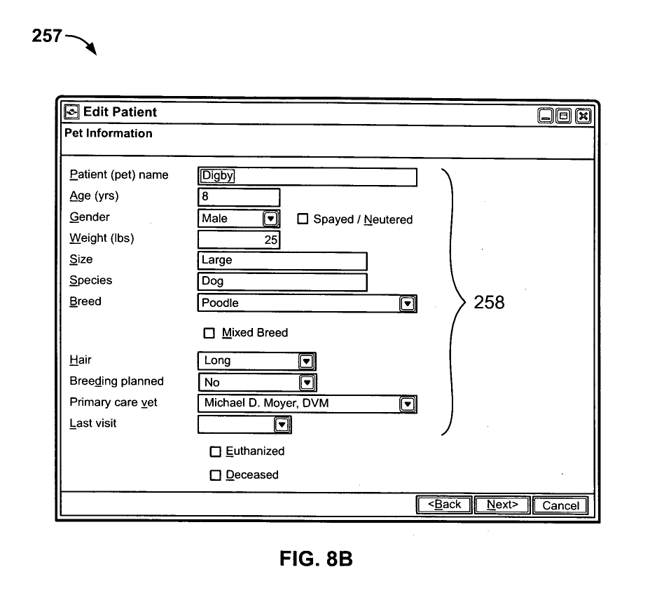

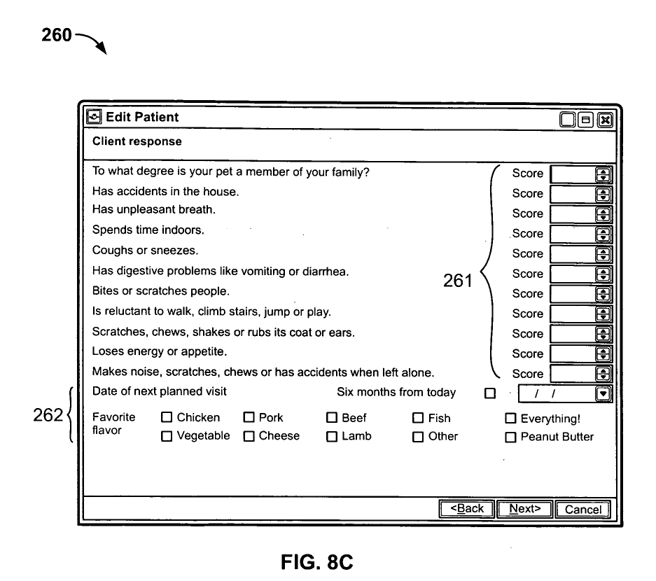

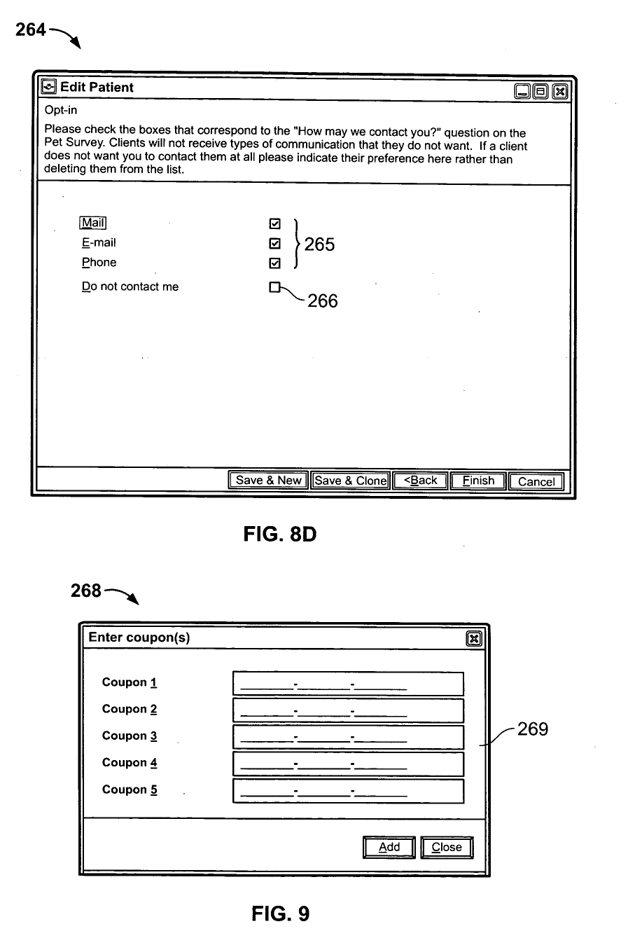

In one preferred embodiment of the present invention, a service provider utilized Data Collection Tool (“DCT”) is provided, which is a software program that provides an easy-to-use graphic user interface that allows employees of a reseller to enter and retrieve information. The DCT software also allows for web-based communication with the Administrator. A new patient is added to a patient or client database by initially obtaining a completed profile form, including a survey questionnaire, and a marketing authorization form where required, e.g., for authorization under HIPPA, from the new patient. The new patient information is added using the DCT via an Add Patient Screen interface 250 as shown in FIG. 8a. Referring to FIG. 8a, the profile of the new patient is entered into a patient profile entry box 252. The personal identifying information is entered according to that provided by the new patient. In addition, various marketing directed questions can be displayed in a questionnaire section 258. FIG. 8b shows a similar screen, but this screen is a Pet Profile Screen 257 and allows for input and edit of pet information in the pet information entry box 258.

Referring to FIG. 8c, there is illustrated a client survey screen 260 for the entry of answers to a variety of survey questions. The client of a data entry person/service can enter in answers to each of the survey questions in Survey answer box 261. The questions are specifically geared towards projecting the need for a product or service of a Vendor that is a part of the Targeted Marketing System. Additional information can be retrieved from a client through additional questions as shown in the personal preference questionnaire section 262. These represent more personal preference questions and can include questions regarding plans on return visits to the Reseller.

FIG. 8d illustrates another client information screen and, specifically, is the Opt-in Screen 264. The Opt-in Screen 264 allows for entry of a patient's interest in participating the Targeted Marketing System and their contact preference selection 265, either by mail, e-mail, or phone. If the patient is not interested in participating, the Opt-in Screen 264 allows for the patient to select that they do not wish to be contacted by checking the no contact box 266.

In one preferred embodiment, patients receive offers through marketing campaigns in the form of coupons for products or services'of a vendor. In order to utilize the coupon, the patient must respond directly to the reseller. Also, in some instances the offer will be contingent on visiting the office or calling the office of the reseller in order to schedule an appointment. An offer code is provided with the coupon and the offer code must be entered into the DCT of the reseller. This is accomplished via a Coupon Screen interface 268 as shown in FIG. 9. The Coupon Screen interface 260 provides entry boxes 269 for entry of one or more coupon codes.

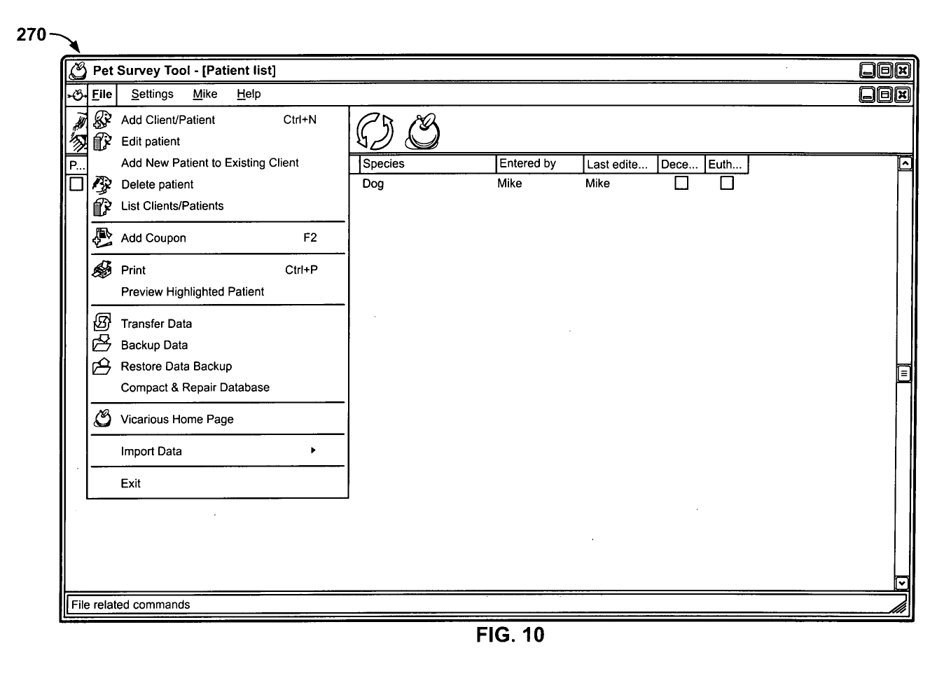

FIG. 10 depicts a typical menu hierarchy of the reseller-side interface 270 provided by the DCT software in accordance with the present invention.

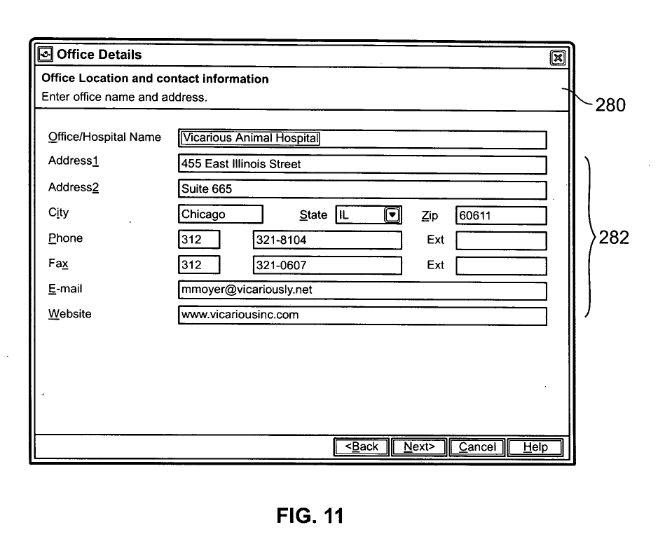

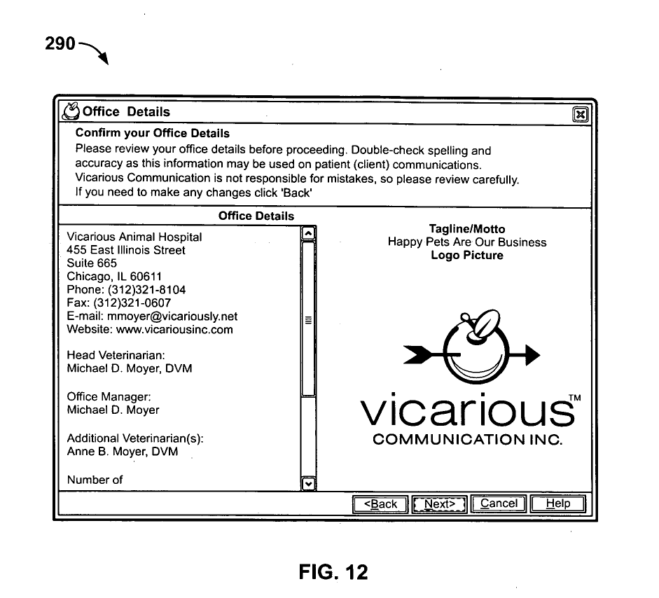

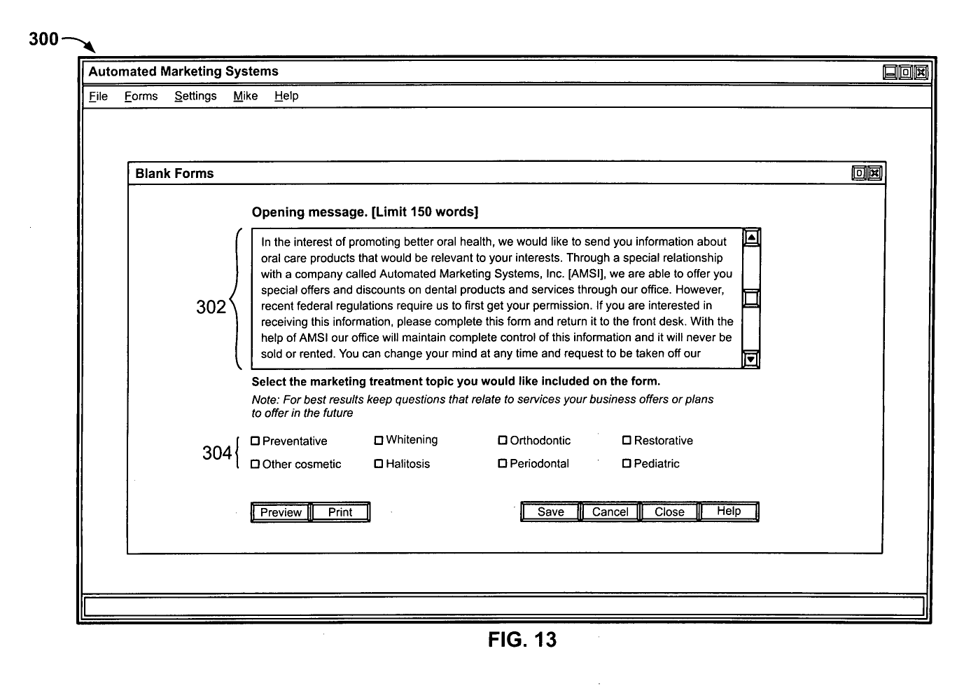

The resellers that participate in the marketing campaigns are required to provide a list of information in order to customize forms and actual direct mail campaigns. This information is made available for viewing over the internet without the ability to edit. Updates to the information can be made by updating the data on the reseller side of the DCT software and transferring the data over the internet to the Administrator. The information about the reseller is entered via a Office Detail Data Entry Screen interface 280 as illustrated in FIG. 11. Entry boxes for office information 282 is provided. After entry of office information, an Office Detail Confirmation Page 290 is displayed as illustrated in FIG. 12.

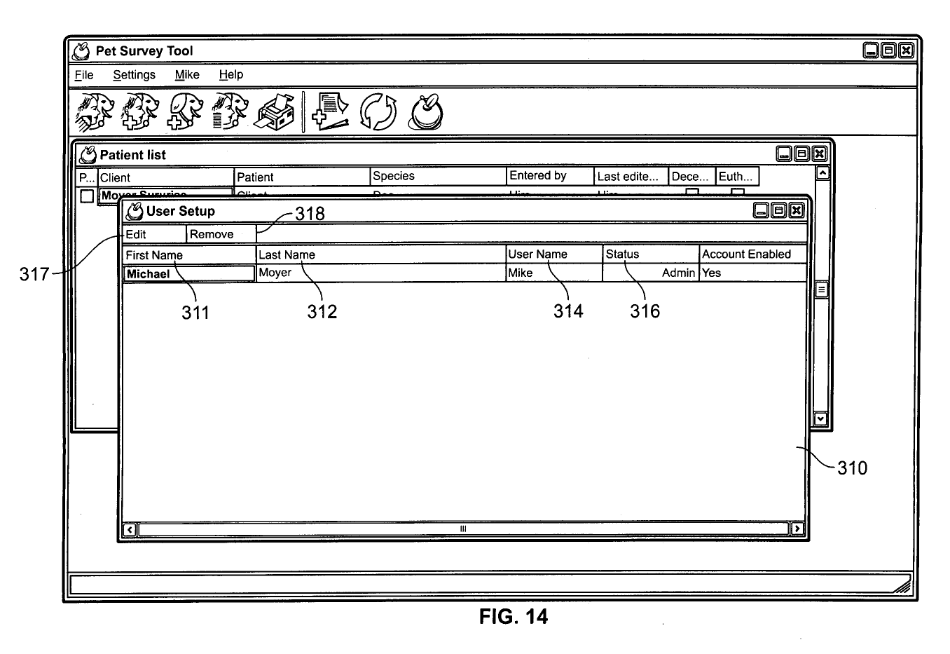

As an incentive to assure that data is entered according to the present invention, an optional reward module or functionality may be included with the system an method. As mentioned, points are assigned for each entry task and a user accumulates points for each entry, which can be redeemed for gifts such as merchandise or travel. The DCT program allows for the addition and storing of user information. Referring to FIG. 14, there is illustrated a User Set-Up interface 310, which provides the users and provides the status level of each. In one embodiment, there is an administrator level, which would constitute a manager-type level within the reseller. Another level would be the staff level and this level could enter data but would not be allowed to change the settings. The User Set-up interface 310 provides columns that include: First name 311, Last name 312, User ID (not displayed), Username 314, Password (not displayed), Status 316, and Edit button 317, and a Remove button 318. Preferably, the User ID and Password are not viewable for security reasons.

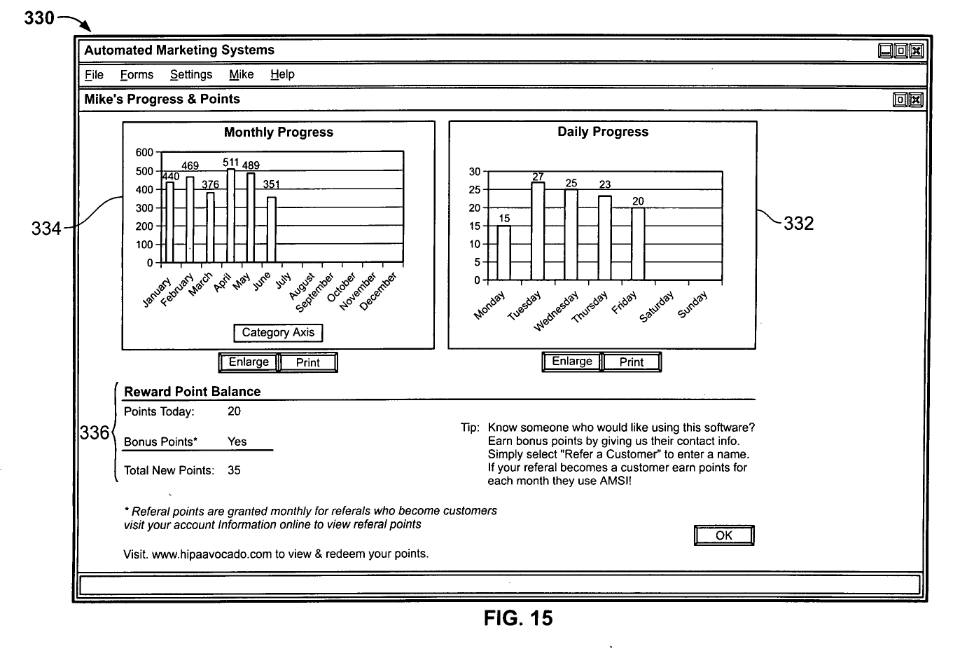

Referring to FIG. 15, there is illustrated a Progress and Points Balance interface 330 that is a part of an optional alternative embodiment. The Progress and Points Balance interface 330 displays point accumulation and charts progress by users employed by the reseller. A graph of the daily progress of users 332 is shown. Additionally, a graph of the monthly progress of users 334 is also shown. The reward point balance 336 is shown for the user, which provides both the total points accumulated and that earned at the present day.

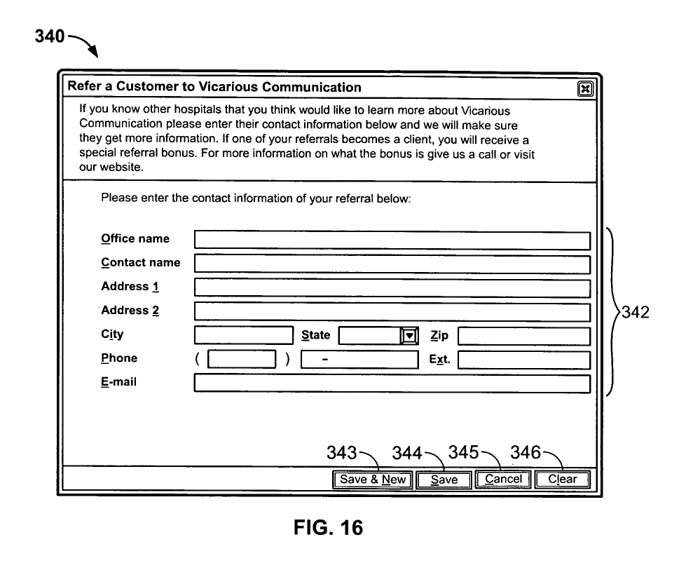

The DCT program allows for a user at a service provider to refer other service providers to utilize the Targeted Marketing System and be rewarded with reward points for doing so. Referring to FIG. 16, there is illustrated a Service Provider Referral interface 340. There are entry boxes for the referred office information 342 provided. Upon entry of this information, the user receives a pre-determined reward point. Also provided are a Save & New button 343, Save button 344, Clear button 345, and Cancel button 346, which allows a user to perform each of the described actions as detailed on the button itself.

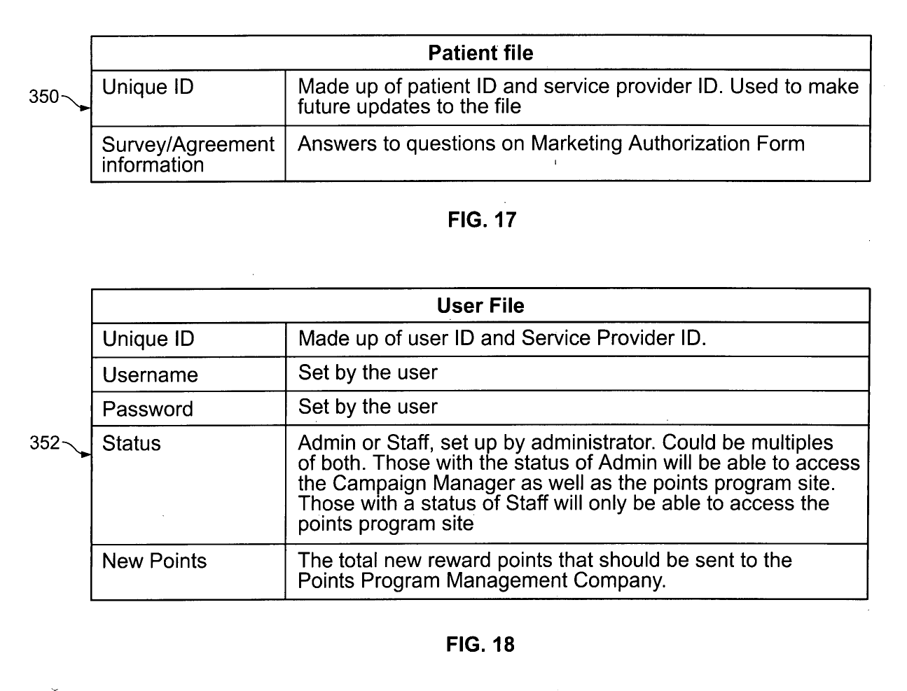

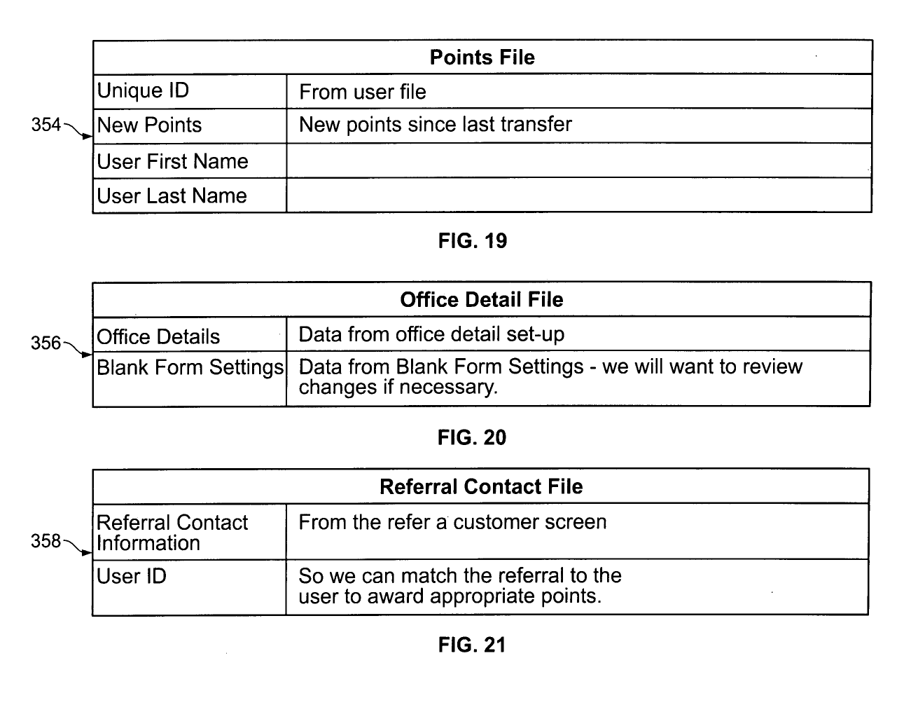

Referring to FIGS. 17 to 21, there are tables displayed that detail the various information that are collected by the DCT program and is utilized in the Targeted Marketing System. FIG. 17 shows a Patient File table 350 that describes the Unique ID and Survey/Agreement information that is provided for each patient file. FIG. 18 shows a User File table 352 that describes the Unique ID, Username, Password, Status and New Points, where enabled for the system, that are provided for each user file. FIG. 19 shows a Points File table 354, which when present or its functionality enabled, describes the Unique ID, New Points, First and Last Name of the User that are provided for each points file. FIG. 20 shows an Office Detail File table 356 that describes the Office Details and Blank Forms Settings that are provided for each office detail file. FIG. 21 shows a Referral File table 358 that describes the Referral Contact information and User ID that are provided for each referral file. The various tables displayed in FIGS. 17-21 represent the types of data that are store, manipulate and accessed using the Targeted Marketing System, and the DCT software in particular.

After all the information is collected by the DCT at the site of the reseller, the information can be communicated with a Web-based Administration Tool (“WAT”). The WAT centralizes the information from the reseller along with the marketing campaigns provided by the vendors. Only the specific reseller has access to their own client/patient database. Preferably, the reseller logs in using their unique identification and password. More preferably, this log in information is different from that for the DCT software.

The service provider also has a Web-based Campaign Launcher (“WCL”) available that allows a reseller to view and launch specific marketing campaigns that match their client database once the reseller has set up an account and populated their own client database. A reseller can log on using the username and password entered into the DCT and transmitted to the WAT, which should be different from the set used for logging onto the DCT software. Once logged on, the reseller can view all the campaigns that match at least one patient in their file.

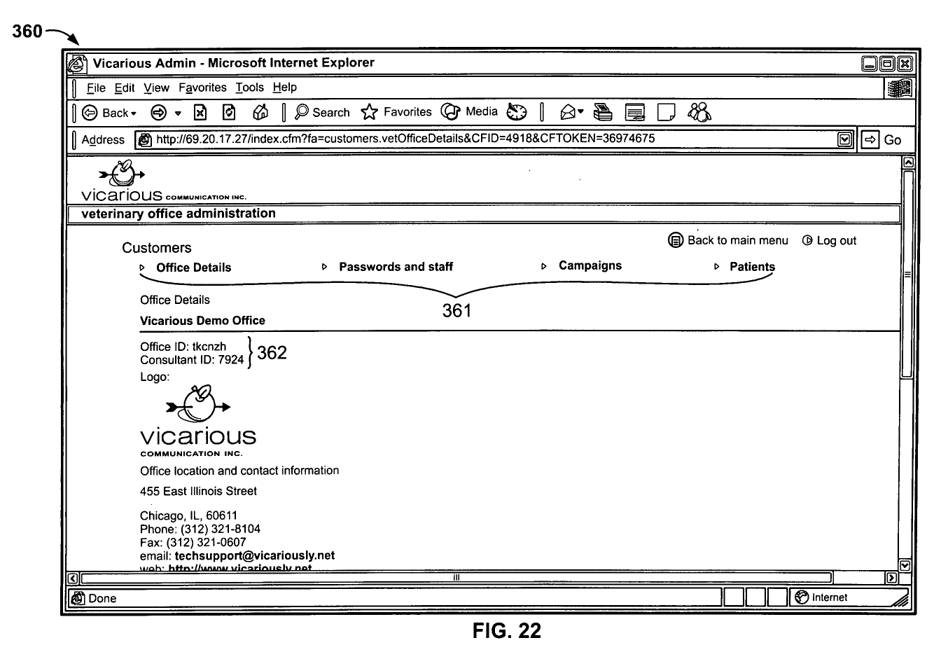

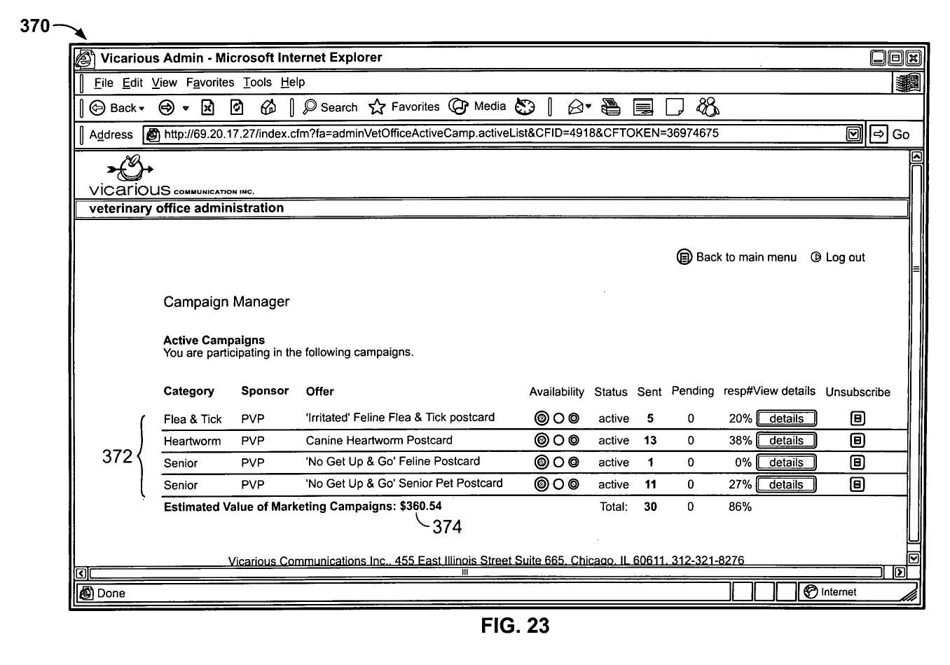

Referring to FIG. 22, there is illustrated a Campaign Launcher Home Page interface 360. This displays the reseller's office information along with links 361 that allow a user of the reseller to access different facets of the WCL. Additionally, the Campaign Launcher Home Page interface 360 provides Reseller identification information 362 in the form of an Office ID and Consultant ID number. Active campaigns can be accessed from this interface and the Active Campaign interface 360 is shown in FIG. 23. In this preferred embodiment, the Active Campaign interface 370 provides a table that includes the following columns: Category, Sponsor, Offer, Availability, Sent, Pending, Resp. (office response rate), View Details, and Unsubscribe. Several sample active campaigns 372 are shown. There is a total marketing value display 374 that provides the service provider with useful information on the value of the marketing campaigns in which they have participated.

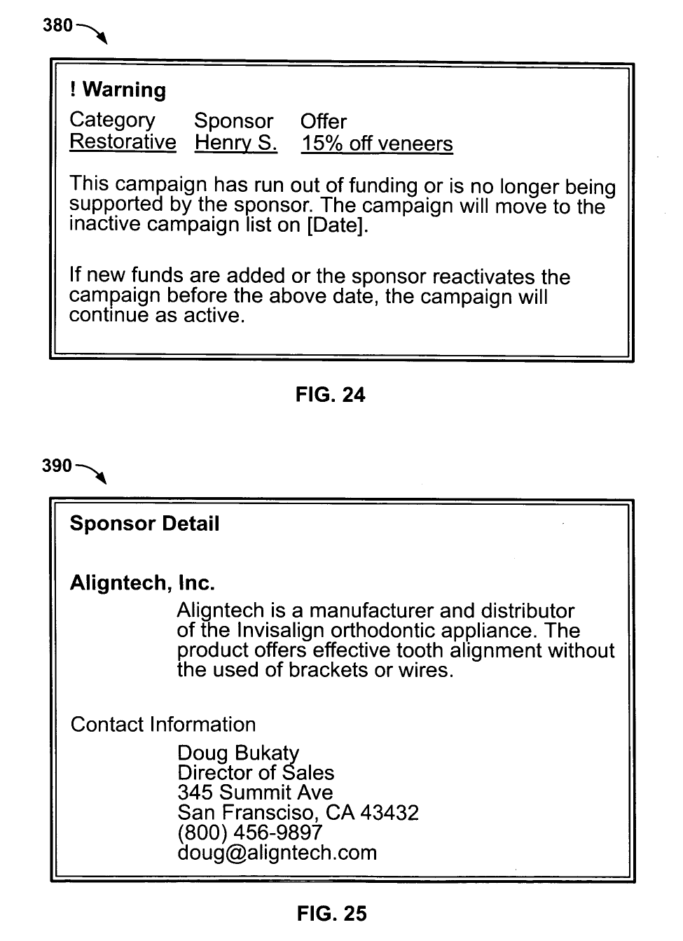

When a specific marketing campaign has become fully funded, or the vendor-sponsor has deactivated the campaign, a Warning Screen 380 as depicted in FIG. 24 may be displayed to the Reseller to notify of the campaign status.

Specific vendor/sponsor information may be accessed from the optional Active Campaign screen 370 in FIG. 23 to provide Sponsor Detail 390 in FIG. 25, and convey descriptive and contact information concerning the Vendor to the Reseller.

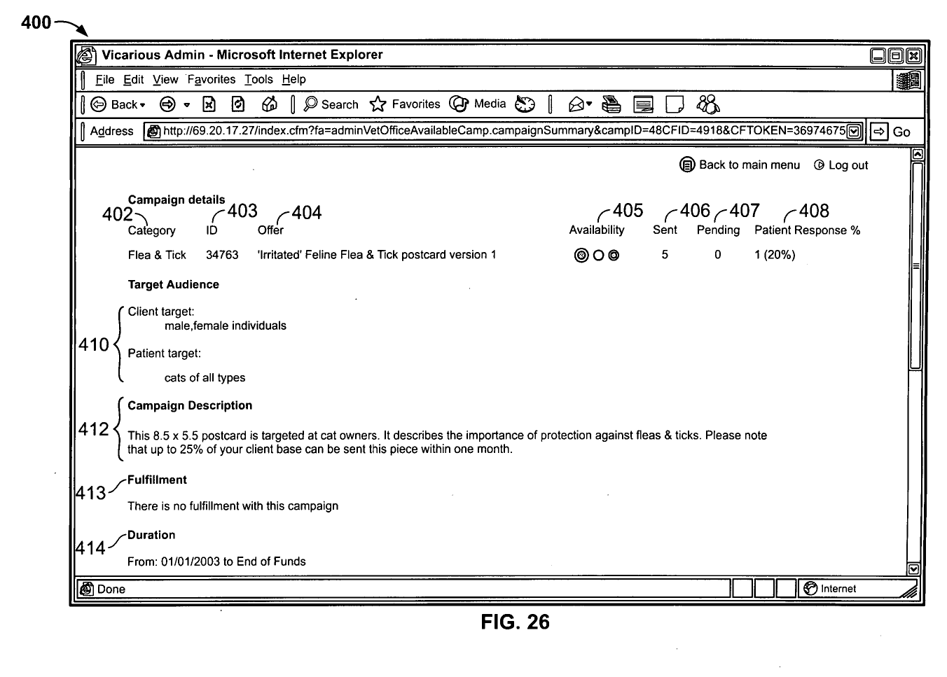

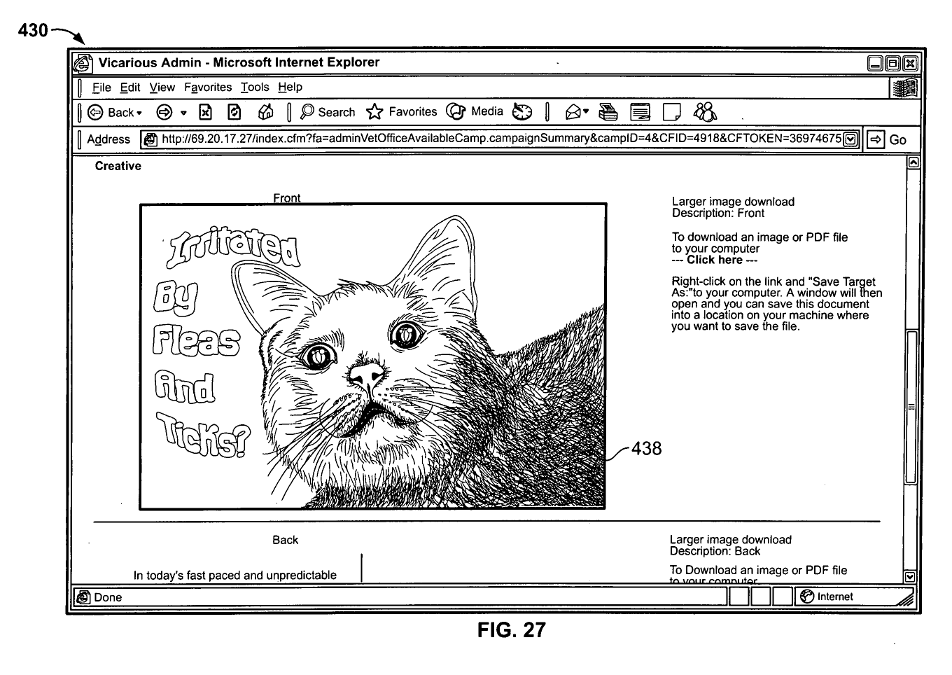

Referring to FIGS. 26 and 27, there is illustrated a Campaign Detail interface that provides details about a particular marketing campaign. The campaign detail interface is comprised of a descriptive campaign display 400 (see FIG. 26) and a creative campaign display 430 (see FIG. 27). The descriptive campaign display 400 provides identification of the marketing campaign, including the category 402, ID 403, Offer 404, Availability 405, Sent 406, Pending 407, and Patient Response % 408. Furthermore, information on the targeted consumer is provided in the Target Audience section 410. The details of the marketing campaign can be found in the Description section 412. A Fulfillment section 413 provides information regarding fulfillment needs with this particular marketing campaign. Additionally, the duration of the marketing campaign is detailed in the Duration section 414. Referring to FIG. 27, the reseller may view a creative campaign display 430 for the same marketing campaign, which that to the information in the descriptive campaign display 430 by providing illustrations or pictures 438 in addition to the descriptions about the marketing campaign. Preferably, the creative campaign display 430 is presented on the same screen or page as the descriptive campaign display 400 (shown in FIG. 26).

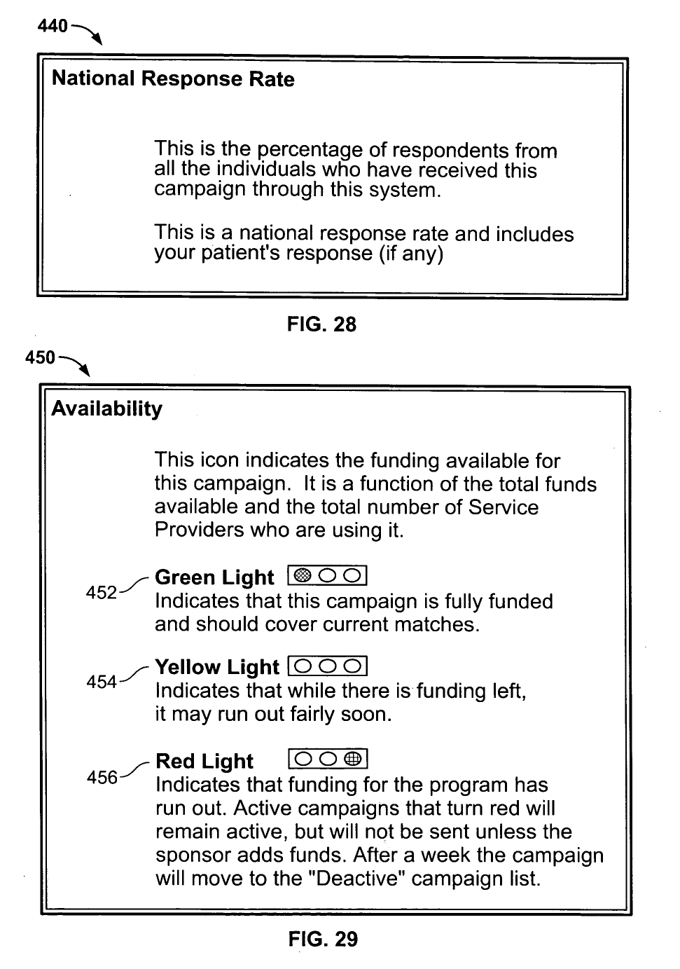

FIG. 28 illustrates an optional National Response Rate display screen 440 at the Reseller which informs the reseller of the National Response Rate associated with a specific vendor-sponsored marketing campaign, against which the Reseller may gauge their relative success of their subscription to the marketing campaign.

A description of the possible designations for the Availability category can be seen in FIG. 29 as an optional Availability description display 450. A Green light designation 452 represents that the campaign is fully funded. A Yellow light designation 454 represents that the campaign has current funding by will need replenishing soon. A Red light designation 456 represents that the campaign has no funding. Once a marketing campaign is designated with a Red light designation 456, this campaign cannot be accessed or sent to a prospective consumer. Preferably, after a week, the campaign will move to the Deactivate campaign list.

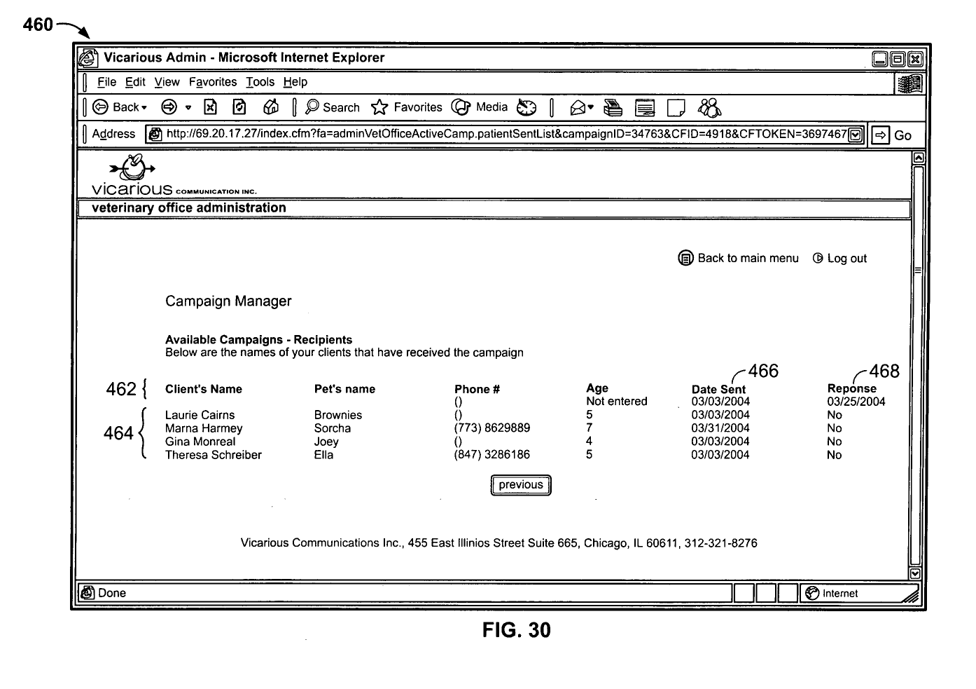

Referring to FIG. 30, there is displayed a Campaign Recipients display 460 for a particular marketing campaign. In the specific example displayed in which the reseller is a veterinary practice, the listed information is in tabular form separated into the following column categories: Client's Name, Pet's Name, Phone #, Age, Date Sent and Response. The sample data 464 is provided as an example. A Date Sent column 466 is provided to identify the date in which the marketing materials were sent to each client. Also, a Response column 468 is provided to designate which clients have responded to this particular marketing campaign.

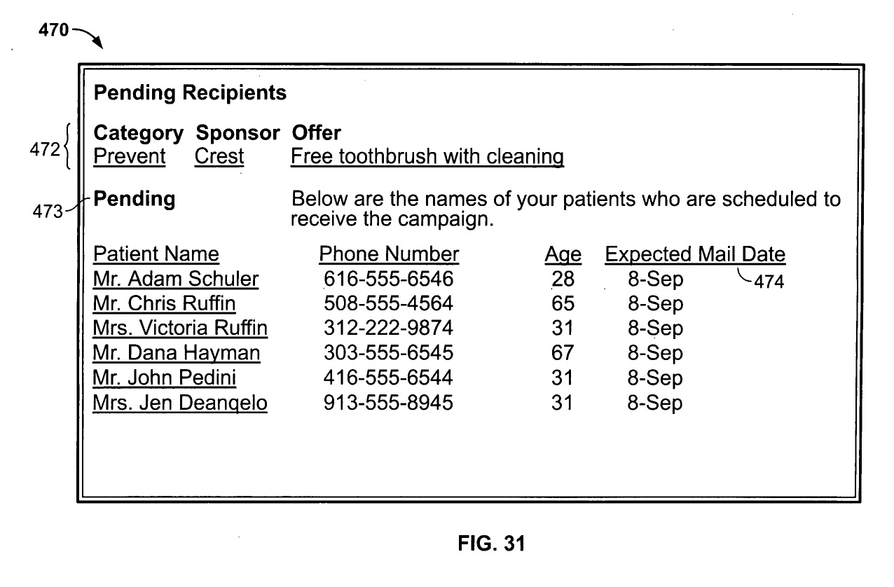

Referring to FIG. 31, there is displayed an optional Pending Recipients display 470 for a particular marketing campaign. The specific marketing campaign is identified by an Identifier 472 that includes the Category 475, Sponsor (or Vendor) 476 and Offer 477. A Pending client list 473 provides a list of clients that have matched the parameters established for the particular marketing campaign but have not been contacted or supplied with the marketing materials. In one preferred example, the list includes the client (or patient) name, the client's phone number, the client's age and the expected mail date. An Expected Mail Date column 474 is provided to list the dates which have been input to designate the dates in which the marketing materials are to be sent to the particular client.

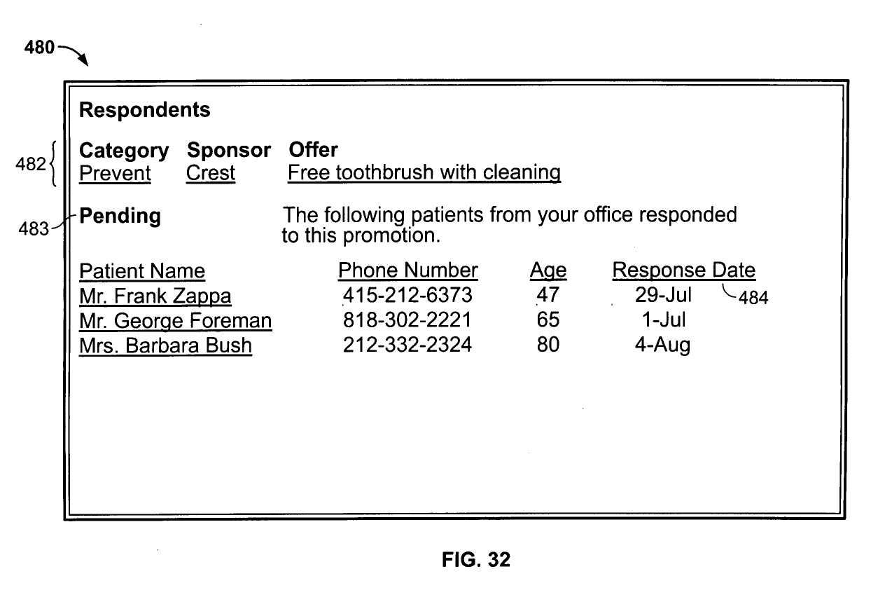

Referring to FIG. 32, which is a subset of information displayed in FIG. 30, there is displayed a Respondents display 480 for a particular marketing campaign. The specific marketing campaign is identified by an Identifier 482 that includes the Category 485, Sponsor (or Vendor) 486 and Offer 487. A Responding list 483 is provided to list the clients of the Reseller that have responded to the particular marketing campaign. In one preferred example, the list includes the client (or patient) name, the client's phone number, the client's age and the response date. There is a Response Date column 484 that lists the date in which the particular client responded to the particular marketing campaign.

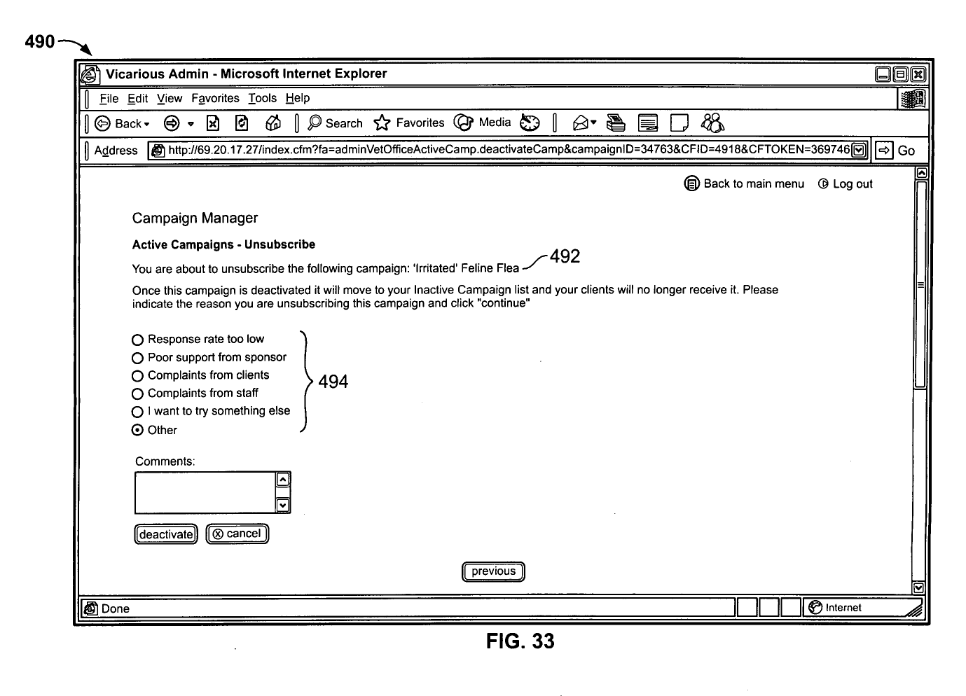

A deactivate link is provided in the WCL tool that allows a user to deactivate a particular campaign. An Unsubscribe interface 490 is shown in FIG. 33. This interface allows the user to unsubscribe to a marketing campaign along with providing a comment on the reason for the deactivation by using the provided reason choices 494. The campaign identification 492 is provided.

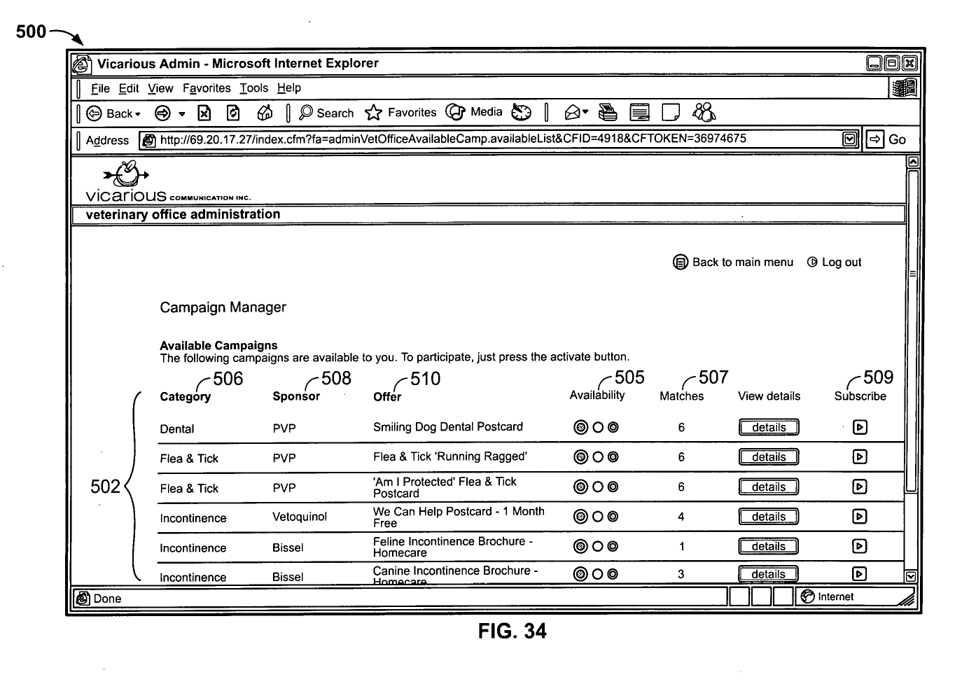

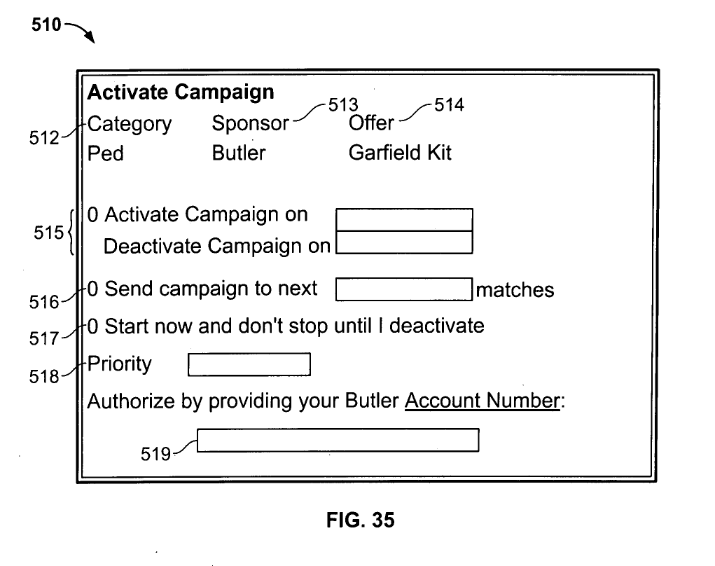

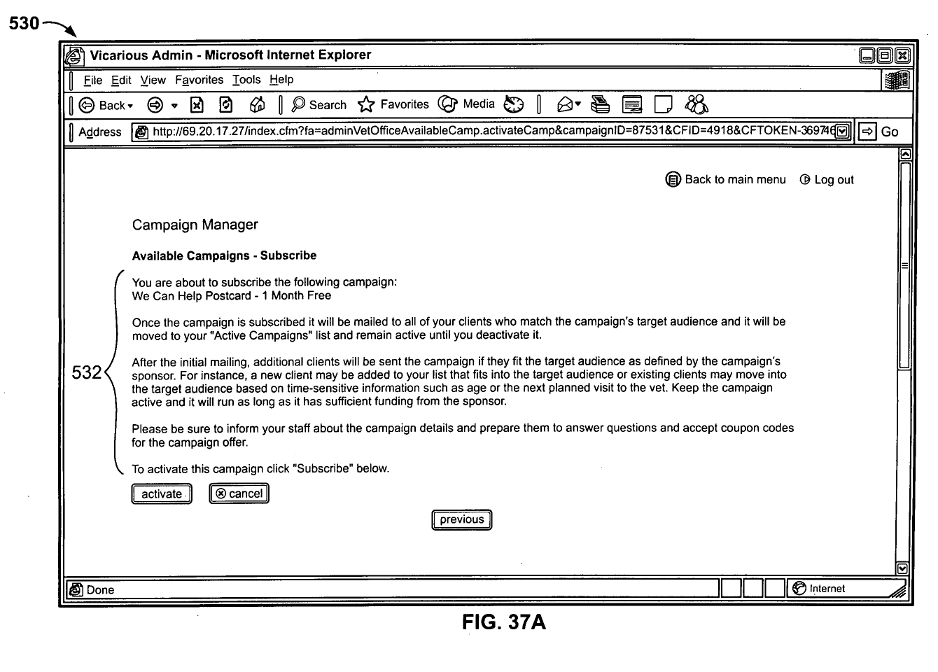

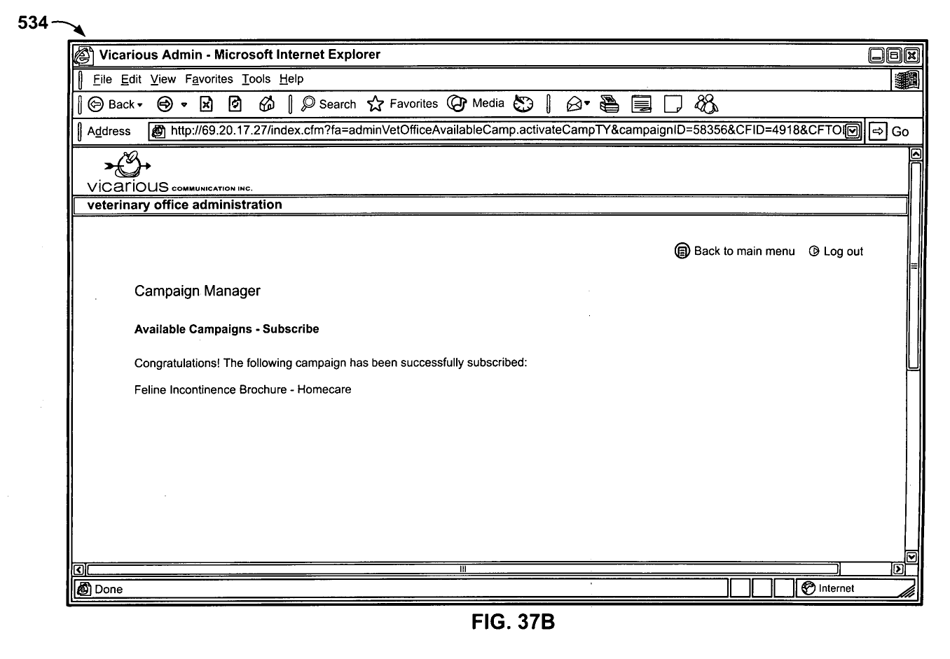

All the available marketing campaigns can be viewed in a Campaign Manager interface 500 as seen in FIG. 34. Corresponding fields for category 506, sponsor (vendor) 508, offer 510, availability 505, matches 507, view details 508, and subscribe 509 are provided in tabular style. In addition, there is an Activation Interface 510 as seen in FIG. 35, which allows a user to activate a campaign. When activating campaigns, the user has three choices on how to run the particular campaign. The first allows a user to set the beginning and end date for the campaign 515. The next allows the user to specify the number of patients that they want to receive the campaign 516. The last allows the campaign to remain active until the campaign runs out of funds or the reseller deactivates 517. A priority level can be selected by entering a representative number, 1 for greatest priority and higher numbers for lower priority designations, in the Priority box 518. An Authorization box 519 is provided to cause the authorization of the activation of this particular marketing campaign. An alternative method for activating a campaign is depicted and described with reference to FIG. 37a.

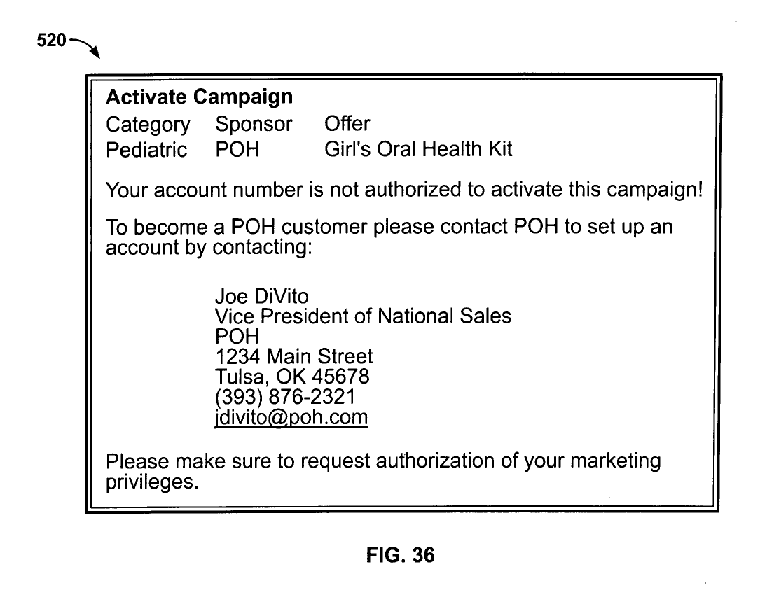

Referring to FIG. 36, there is displayed an optional Unauthorized Account Number display 520, which informs the Reseller that there is a problem with the activation of this particular marketing campaign. On the other hand, when the marketing campaign has been successfully activated, a Campaign Activated display 530 is displayed as shown in FIG. 37a. The Campaign Activated display 530 optionally includes a detail instruction section 532 that describes the procedure in which the marketing campaign will be run. Once the marketing campaign has been successfully activated a Successful Activation screen 534 appears.

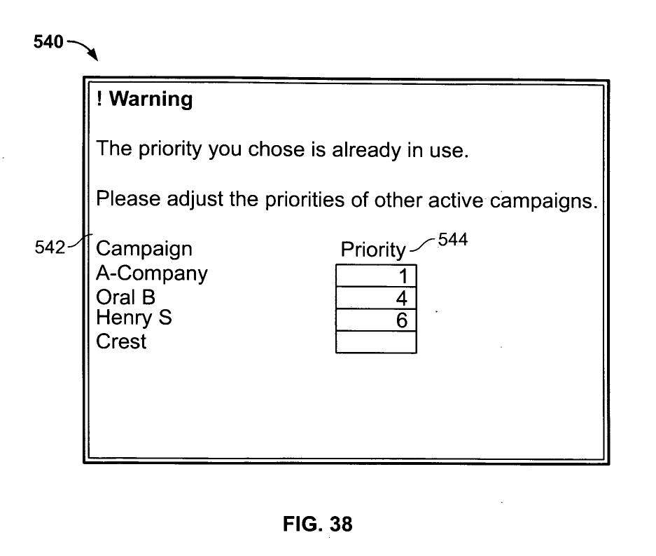

In helping to select a marketing campaign for a particular patient/client, there is an optional Campaign Priority interface 540 as seen in FIG. 38 that allows a Reseller, via a User, to prioritize multiple matching marketing campaigns for each patient/client, if needed. A Campaign column 542 is provided for listing matched marketing campaigns, and a Priority box 544 is provided alongside the listed marketing campaign for entering the priority level of this particular marketing campaign. This way, in the event that a patient matches two or more campaigns, the campaign with the higher priority will be sent.

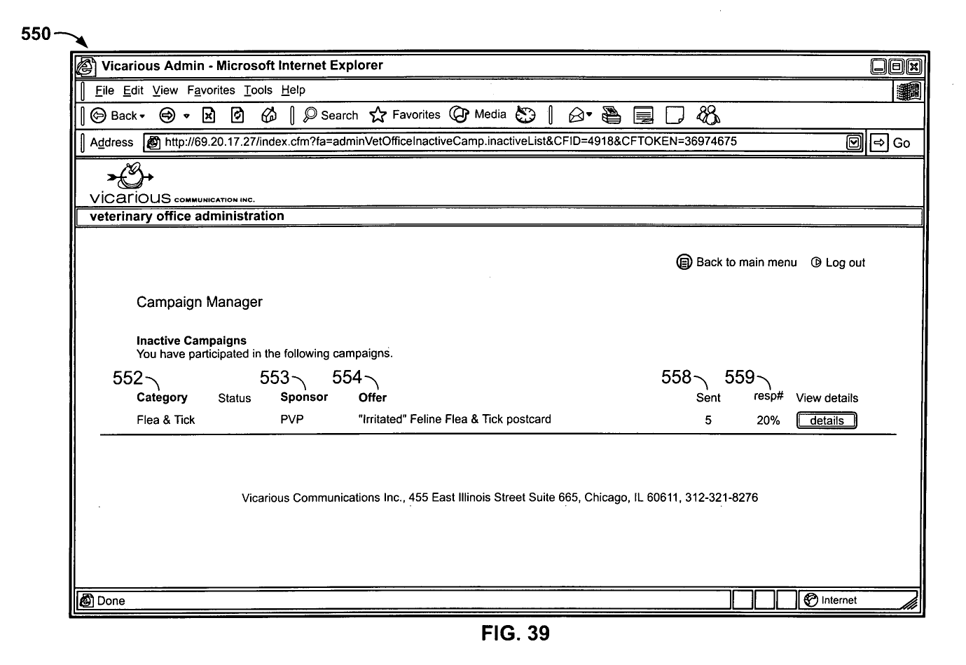

For the campaigns that are inactive, whether because of lack of funding or deactivation, there is an Inactive Campaign Screen 550, shown in FIG. 39. The Inactive Campaign Screen 550 allows a user to manage the inactive campaigns by viewing information about all the inactive campaigns. Data are provided in tabular format with the following column headings: Category 552, Sponsor (or Vendor) 553, Offer 554, Sent 558, Resp. (Response percentage) 559, and View Details 560. After a campaign is active it will move back to the active campaign display.

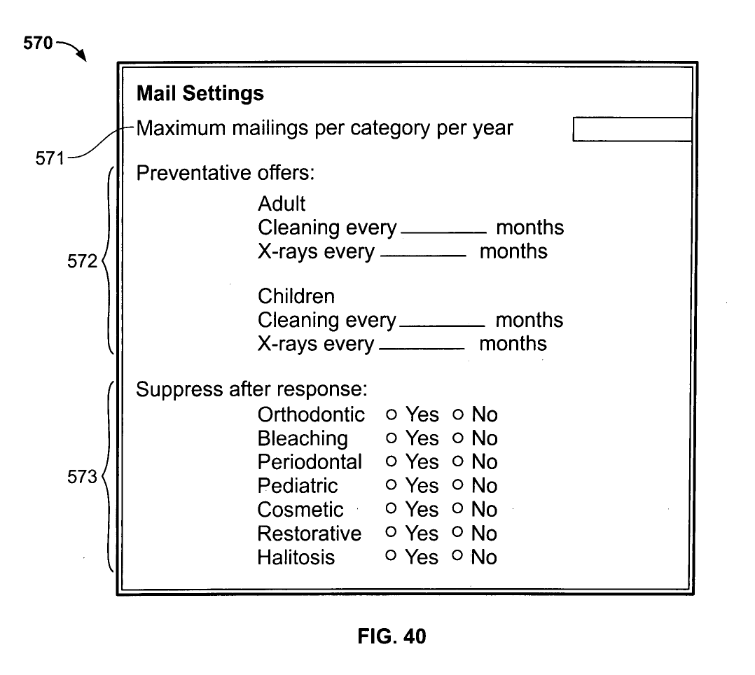

Typically, the marketing campaigns incorporate sending marketing material, preferable coupons, through mailings from the Reseller. Many of the mail settings are entered in the DCT by a user but some basic mailing settings can be managed using the WCL tool. The optional Mail Setting Interface 570 is shown in FIG. 40. In this example of a preferred embodiment, where the Reseller is a dental office, the user can set a maximum number of mailings per year to each patient 571. The user also can set the suggested cleaning intervals for children and adults 572. The user can decide not to send campaigns to people for products that they may have already bought 573.

In addition to the DCT and WCL tools for the service provider, the Targeted Marketing System also includes a Web-based Campaign Manager (“WCM”) for the vendor. This allows vendors who are enrolled in the Targeted Marketing System to log-on to access the WCM. These tools allow the vendor to view a list of pending, active and inactive campaigns; view details of each campaign; and allow the marketing and sales department to track the success of their marketing efforts.

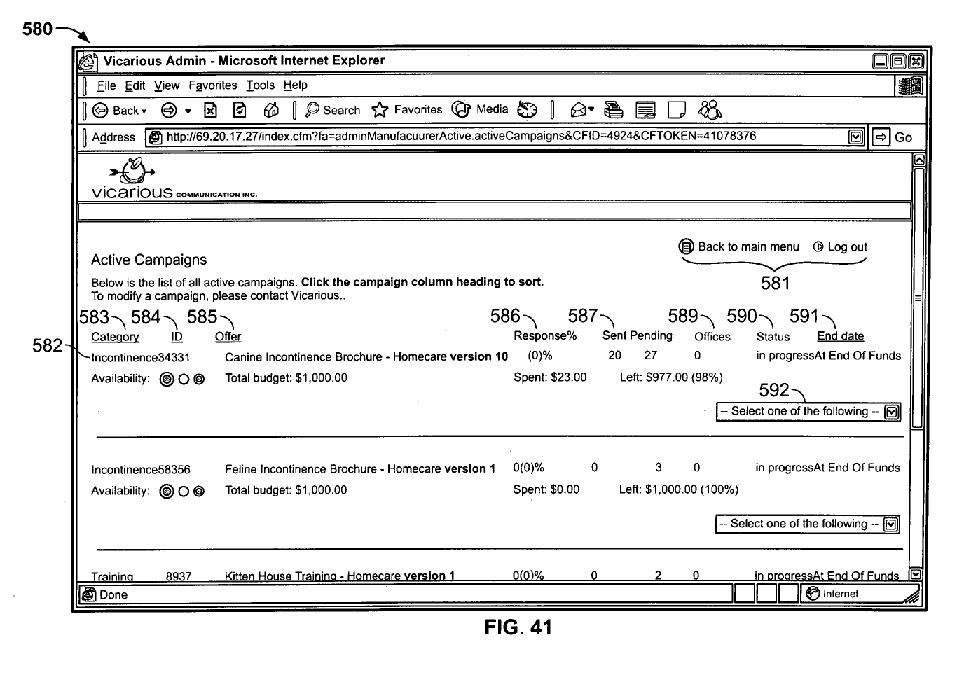

Referring to FIG. 41, there is shown a Campaign Manager Homepage 580 that serves as the homepage for a vendor when using the WCM. The Campaign Manager Homepage 580 provides menu items 581 that includes Back to Main Menu and Log out options. There is a campaign table 582 that provides various information about each marketing campaign and is displayed in tabular form with columns designated: Category 583, ID 584, Offer 585, Resp. (response percentage) 586, Sent 587, Pending 588, Offices 589, Status 590 and End date 592. Budget details are provided for each marketing campaign in a Budget description section 593. This includes the availability designation for the campaign, along with details on the total budget, amount spent, and amount remaining. An action selection box 592 provides a variety of options to take with regard to the associated marketing campaign, e.g., unsubscribe to the campaign or get detailed reports.

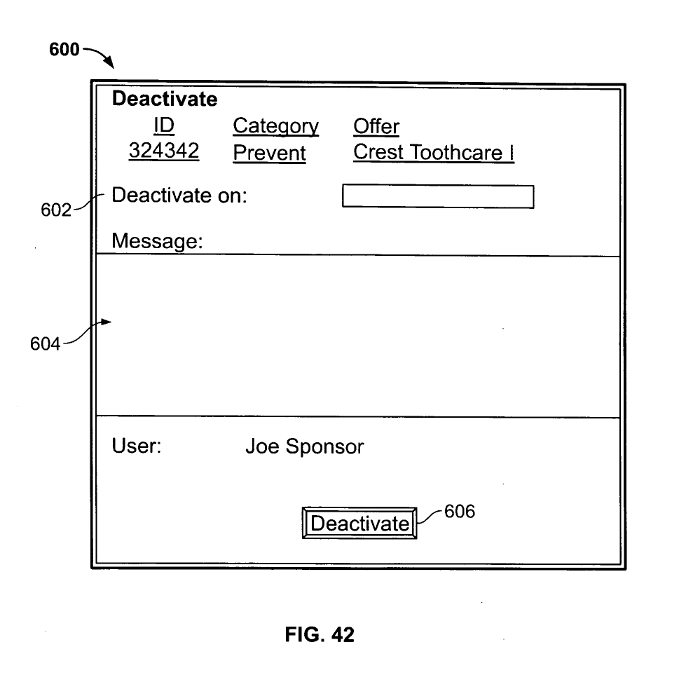

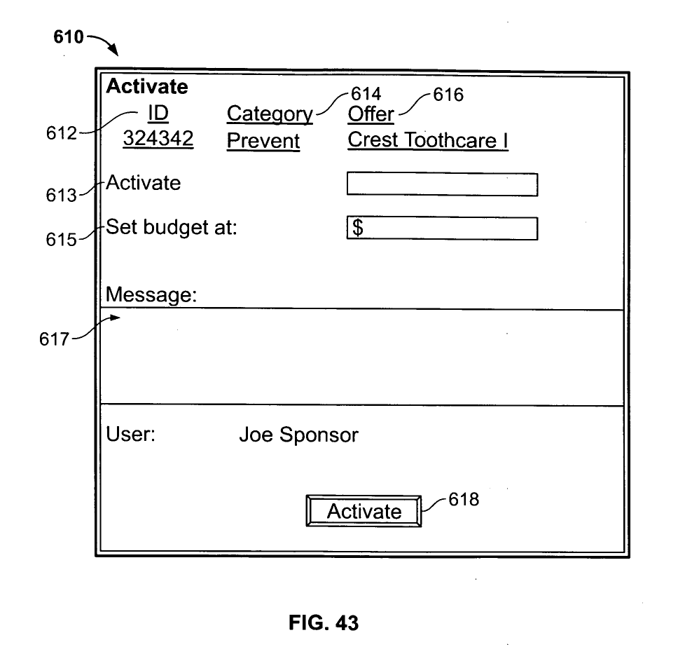

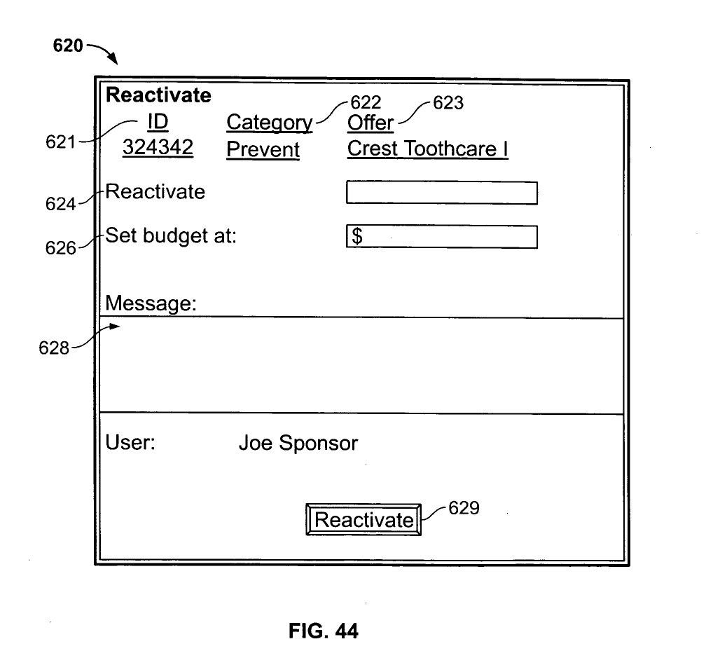

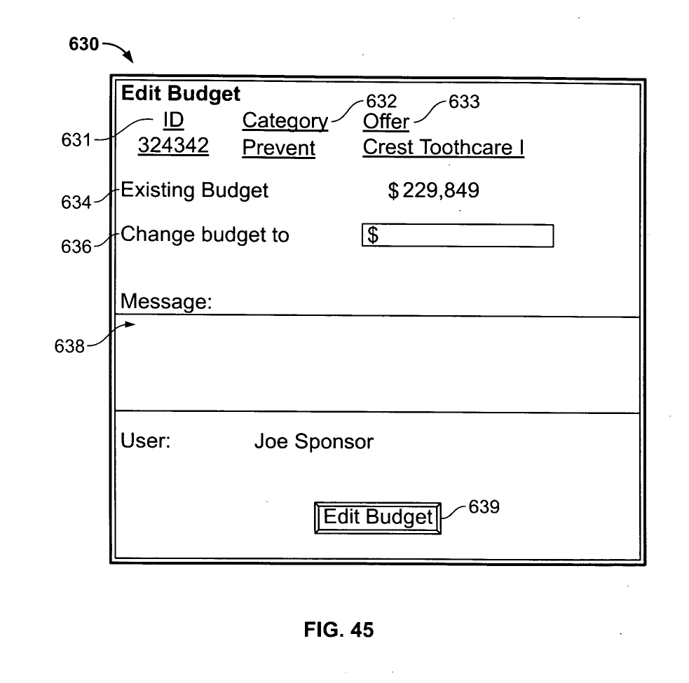

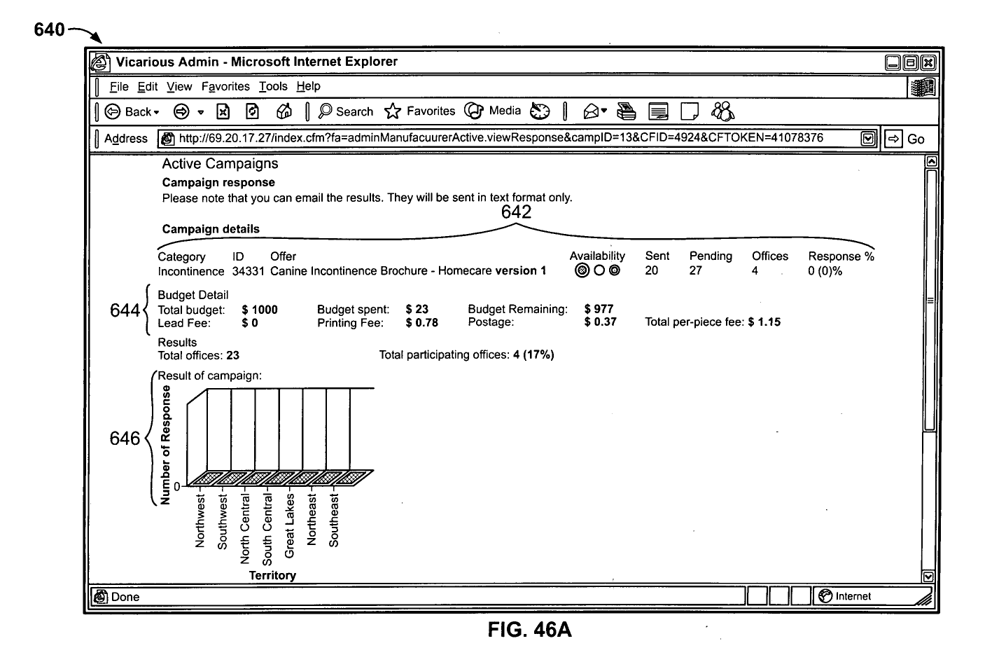

Referring to FIGS. 42-45, there is shown optional functionalities represented by screen displays that are accessed through the Campaign Manager Homepage 580 that allows a user from the vendor-side to activate, deactivate, reactivate, or edit a budget of a marketing campaign. FIG. 42 shows a Deactivation Screen 600 that allows the user to deactivate a campaign. The marketing campaign to be deactivated is identified in the Identification header 601, which includes the ID, Category and Offer. A date for deactivation is entered in a Deactivation box 602 and any comments are added in the Message box 604. The deactivation is processed by clicking the Deactivate button 606. Upon deactivation, the campaign is moved to an inactive list. FIG. 43 shows an Activate Screen 610 that allows a user to activate a campaign and allot a budget to the campaign. The marketing campaign to be activated is identified in the Identification header 611, which includes the ID 612, Category 614, and the Offer 616. The date for activation is provided in a Activate box 613. Additionally, the budget amount is provided in the Set Budget box 615. Any messages concerning this activation can be entered in the Message box 617. After all the information is entered, the activation is processed by clicking the Activation button 618. FIG. 44 shows a Reactivate Screen 620 that allows a user to reactivate an inactive campaign, e.g., if there is extra funds to add to a campaign that recently lacked funds. The marketing campaign to be reactivated is identified in the Identification header 625, which includes the ID 621, Category 622 and Offer 623. The date for reactivation is entered into the Reactivate box 624. In addition, the budget amount is provided in the Set Budget box 626. Any comments regarded this particular reactivation can be entered in the Message box 628. Thereafter, the reactivation is processed by clicking the Reactivate button 629. FIG. 45 shows an Edit Budget Screen 295 that allows a user to change the budged of a marketing campaign. The marketing campaign to be edited is identified in the Identification header 635, which includes the ID 631, Category 632 and Offer 633. The existing budget is displayed in the Existing Budget line 634. Any changes to this budget is entered in the Change Budget box 636. Furthermore, any comments regarding the edit to the budget is entered in the Message box 638. After all this information has been entered, the editing is processed by clicking the Edit Budget button 639.

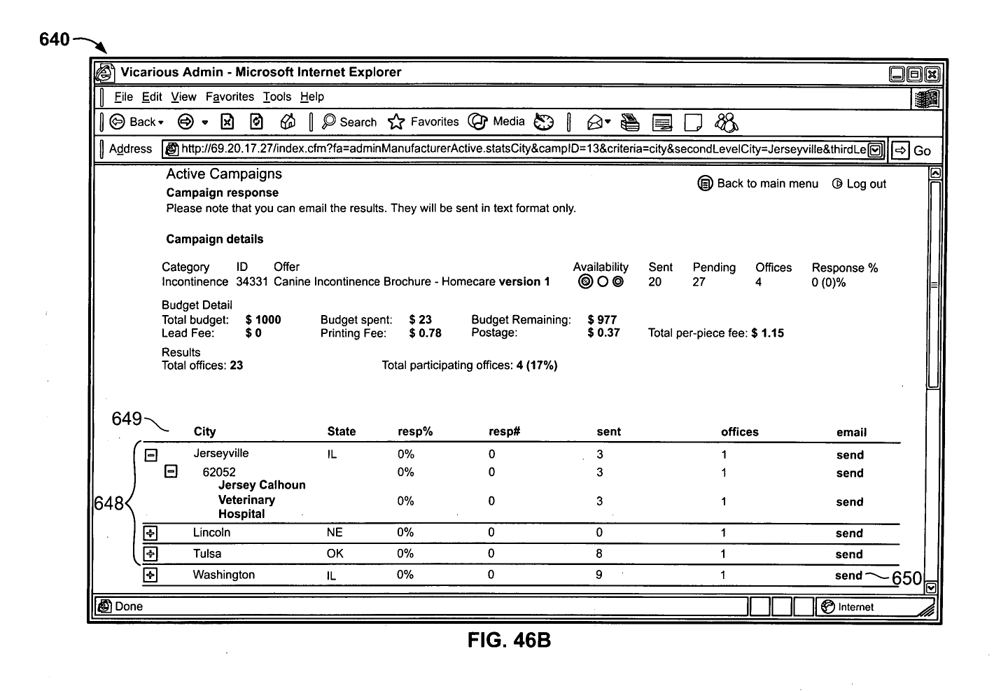

Ultimately, the vendor is interested in viewing the success of each of their marketing campaign. Referring to FIG. 46a, there is illustrated a Campaign Report interface 640. A user is able to access reports for each active and inactive campaign by clicking a report link next to the individual campaign. See action selection box 592 in FIG. 41. The Campaign Report interface 640 provides a Report Header 642 that provides the ID, Category, Offer, Availability, Resp. (response percentage), Sent, Pending, and Offices for the particular marketing campaign selected. A Budget Details section 644 provides detailed information on the campaign's budget. In one example, the Budget Details section 644 provides the following: Total budget, budget spent, budget remaining, lead fee, printing fee, postage, and total per-piece fee. There is also a Results section 646 that provides a more detailed report on the results of the marketing campaign. The Results section 646 is shown to include the number of offices participating and the total offices. Also, a geographic breakdown of the responses are shown in a Territory graph 647. Each particular geographic territory that is provided by the Territory graph 647 can be further parsed into smaller geographic areas. An example of this is shown in FIG. 46b, which also shows the Campaign Report interface 640. Here, the interface shows details of a selected geographic area 648. The selected geographic area 648 can be further parsed by selecting each of the individual areas, e.g., section of US can be parsed into specific states, which can then be parsed into specific cities, etc. The information for the selected geographic area 648 is provided in tabular format with the following categories as column headers: City, State, Resp. %, Resp. #, Sent, Offices, and email. The email column 650 provides a link for each respective location.

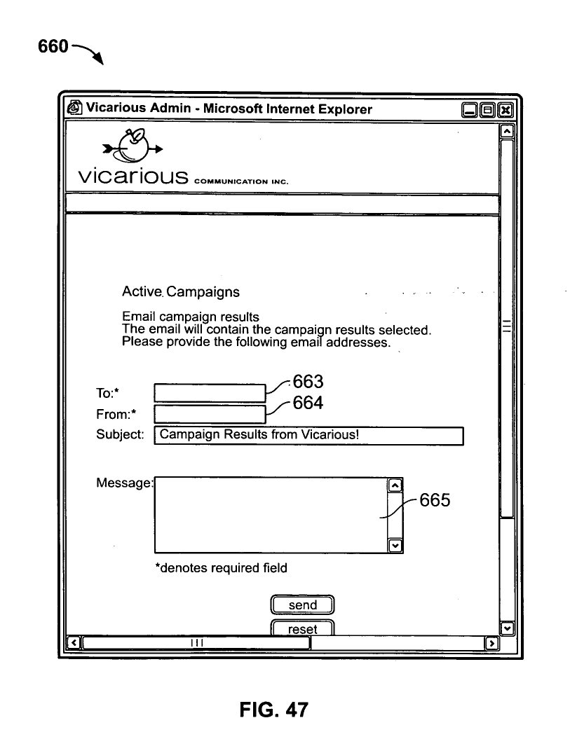

For each row of geographic location in the Campaign Report interface 640, there is an e-mail link 650, which opens an e-mail interface 660 as shown in FIG. 47. This interface is used to set email communication parameters to provide results of a particular, selected geographic area in a quick and easy manner. A To box 663 is provided to input the recipient's email address. Accordingly, there is a From box 664 for the input of the sender's email address. A message box 664 is provided so the sender can provide additional information along with the results provided by the Targeted Marketing System. This is a convenient way to provide specific reports in a marketing campaign to the right people who are designated to review the results of the marketing campaign for the Vendor. Furthermore, the automatic, periodic reporting option provides a convenient way to receive the reports on a regular interval.

While the foregoing describes the present invention with reference to its preferred embodiments, optional functionalities which may be added as alternative embodiments, and exemplary system-level implementation, those of ordinary skill in the art will understand that the invention as described is merely illustrative in nature and is not to be considered limiting except by the claims appended hereto.

1. A method of targeted marketing products or services of a vendor to a prospective customer, where the prospective consumer is an customer of a reseller, comprising the steps of:
a. compiling a database of prospective consumer profiles by acquiring selected information about the prospective consumers maintained or generated by the reseller;
b. establishing a vendor marketing campaign having a plurality of pre-determined parameters;
c. comparing the prospective consumer profiles with the pre-determined parameters of the vendor marketing campaign;
d. selecting prospective consumer profiles corresponding to at least one of the predetermined parameters;
e. providing a product or service offer associated with the vendor marketing campaign, and identified with the intermediate reseller, to prospective consumers identified in the selected prospective consumer profile; and
f. collecting a response from at least some of the prospective consumers identified in selected prospective consumer profiles.

2. The method according to claim 1, further comprising the step of reporting response information collected in step f such that the privacy of personally identifiable consumer data is secured from the vendor.

3. The method according to claim 1, further comprising the steps of calculating a response rate to the product or service offer, and determining whether to adjust the pre-determined parameters of the vendor marketing campaign.

4. The method according to claim 1, wherein the compiling step further comprises the step of inputting prospective consumer answers to survey questions into the database of prospective consumers.

5. The method according to claim 1, wherein the step e further comprises the step of creating a product or service offer based upon the pre-determined parameters of the vendor marketing campaign and encoding the product or service offer with a unique identifier corresponding to the intermediate reseller.

6. The method according to claim 5, wherein the product or service offer is selected from at least one eligible product or service offer specified by the vendor for the vendor marketing campaign.

7. The method according to claim 6, wherein the plurality of eligible product or service offers are selected from a group of product or service offers for the marketing campaign and the plurality of eligible product or service offers are valid for prospective consumers matching the pre-determined parameters of the vendor marketing campaign.

8. The method according to claim 6, wherein the reseller selects the at least one eligible product or service offer from active vendor marketing campaigns.

9. The method according to claim 1, further comprising the step of determining active vendor marketing campaigns.

10. The method according to claim 9, further comprising the step of displaying active vendor marketing campaign availability to the reseller.

11. The method according to claim 10, further comprising the step of assigning an indicia to a vendor marketing campaign, the indicia selected from the group of a first indicia indicative of an active and available vendor marketing campaign, a second indicia indicative of an active and available vendor marketing campaign that is nearing completion, and a third indicia indicative of an active and unavailable marketing campaign.

12. The method according to claim 5, wherein the product or service offer is branded to the reseller.

13. The method according to claim 1, further comprising the step of the reseller approving the product or service offer associated with the vendor marketing campaign prior to the product or service offer being communicated to prospective consumers.

14. The method according to claim 1, further comprising the step of providing incentives to the reseller based upon the number of prospective consumer profiles acquired in step a.

15. The method according to claim 1, wherein the steps a through f are conducted between a plurality of remote computers.

16. The method according to claim 15, wherein the plurality of remote computers connect over the internet.

17. The method according to claim 1, further comprising:
a. A repository containing vendor specified marketing programs;
b. A database of vendors.

18. A system for executing the method according to claim 1, comprising:
a. A consumer interface;
b. A plurality of central objects; and
c. A plurality of data sources.

19. The system according to claim 18, wherein the consumer interface further comprises a web browser, a secured web service, at least one data entry means for entering survey data and at least one vendor desktop consumer.

20. The system according to claim 19, wherein the plurality of central objects further comprise a web server and an application server.

21. The system according to claim 20, wherein the application server further comprises a consumer response analysis module, a vendor marketing campaign rules module, a vendor marketing campaign management module, a vendor data synchronization module and a vendor data standardization module.

22. The system according to claim 18, wherein the plurality of data sources further comprise a central repository, an data access protocol repository and a vendor desktop consumer database.

23. The method according to claim 1, wherein the pre-determined parameters further comprise at least one of campaign budget, campaign response rate, prospective customer target identification, offer description and fulfillment description.

24. The method according to claim 1, further comprising the steps of querying the reseller to enter information relating to the product or service offer.

25. The method according to claim 24, further comprising the step of displaying to the reseller an image of the product or service offer.

26. The method according to claim 12, wherein the assigning step further comprises selecting the indicia based upon a determination of available budgeted funds remaining in each vendor marketing campaign marketing program.

27. The method according to claim 1, wherein the product or service offer further comprises a consumer incentive.

28. The method according to claim 1, wherein the collecting step further the step of the consumer redeeming the product or service offer.

29. The method according to claim 28, wherein the collecting step further comprises recording the redeemed product or service offer and updating the vendor marketing campaign to reflect the redeemed product or service offer.

30. A system for allowing a vendor to selectively market products or services to a prospective consumer belonging to an intimate consumer database of a reseller, comprising:
a. At least one computer means having a graphical user interface, means for inputting data into the computing means, means for storage and retrieval of data input into computer means, and means for communicating with remote computer means;
b. At least one database accessible by the at least one computer means and containing vendor information, vendor marketing campaign information, prospective consumer information, product or service offers and reseller information; and
c. Means for processing data in the at least on database to compare prospective consumer profiles with pre-determine parameters of a vendor marketing campaign, qualifying prospective consumer profiles based upon the pre-determined parameters, flagging a vendor marketing campaign for qualified prospective consumer profiles, identifying at least one product or service offer valid for the flagged vendor marketing campaign, selecting at least one product or service offer, approving communications pertaining to the at least one product or service offer, communicating the selected at least one product or service offer, and redeeming product or service offers from responding prospective consumers.
